(19) United States
(12) Patent Application Publication
(10) Pub. No.: US 2011/0241583 A1
(43) Pub. Date: Oct. 6, 2011

(54) CONTROL DEVICE OF MOTOR DRIVING APPARATUS

(75) Inventors: Peng HE, Anjo (JP); Subrata SAHA, Anjo (JP); Ken IWATSUKI, Anjo (JP)

(73) Assignee: AISIN AW CO., LTD., ANJO-SHI (JP)

(21) Appl. No.: 13/018,953

(22) Filed: Feb. 1, 2011

(30) Foreign Application Priority Data
Mar. 31, 2010 (JP) 2010-081515

(51) Int. Cl. H02P 27/08

(52) U.S. Cl. 318/400.09

(57) ABSTRACT

Disclosed is a control device capable of ending strong field control in a structure that performs strong field control and square wave control on the basis of a voltage index, such as a modulation factor. A voltage waveform control unit performs PWM control when a voltage index is less than a threshold, and performs square wave control when the voltage index is equal to or greater than the threshold value. A field adjusting unit performs strong field control when the voltage index is equal to or greater than a predetermined strong field threshold value less than the square wave threshold value. A mode control unit ends the strong field control when a field adjustment command value is equal to or greater than an adjustment command threshold value determined on the basis of a target torque and a voltage/speed ratio in a direction in which field flux is strengthened.

### INCORPORATION BY REFERENCE

The disclosure of Japanese Patent Application No. 2010-081515 filed on Mar. 31, 2010, including the specification, drawings and abstract thereof, is incorporated herein by reference in its entirety.

### BACKGROUND OF THE INVENTION

1. Field of the Invention

The present invention relates to a control device that controls a motor driving apparatus including a DC/AC conversion unit which converts a DC voltage into an AC voltage and supplies the AC voltage to an AC motor.

2. Description of the Related Art

Motor driving apparatuses have been generally used in which an inverter converts a DC voltage from a DC power supply into an AC voltage for driving an AC motor. In the motor driving apparatus, maximum torque control and sine wave PWM (pulse width modulation) control based on vector control are generally performed in order to supply a sine-wave-shaped AC voltage to coils corresponding to each phase in the AC motor to effectively generate torque. However, in the motor, as the rotational speed increases, an induced voltage increases and an AC voltage (hereinafter, referred to as a “necessary voltage”) required to drive the motor also increases. When the necessary voltage is higher than the maximum AC voltage (hereinafter, referred to as a “maximum output voltage”) that can be output from the inverter, it is difficult to supply the necessary current to the coil and appropriately control the motor. Weak field control for weakening the field flux of the motor is performed in order to reduce the induced voltage. When the weak field control is performed, it is difficult to perform the maximum torque control. Therefore, the maximum torque that can be output is reduced and efficiency is also reduced.

In order to solve the above-mentioned problems, JP-A-2006-311770 discloses the technique of a control device of a motor driving apparatus that sequentially changes a control mode from sine wave PWM control to overmodulation PWM control and square wave control as the rotational speed of the motor increases and the induced voltage increases. In the sine wave PWM control, the upper limit of a modulation factor indicating the ratio of the effective value of a fundamental wave component of an AC voltage waveform to a DC power supply voltage (system voltage) is 0.61. In contrast, it is possible to increase the modulation factor to the range of 0.61 to 0.78 in the overmodulation PWM control, and the maximum modulation factor is 0.78 in the square wave control. Therefore, the control device disclosed in JP-A-2006-311770 performs the overmodulation PWM control or the square wave control to increase the amplitude of the fundamental wave component of the AC voltage waveform supplied to the AC motor (increase the modulation factor), thereby effectively using the DC voltage and expanding the rotational speed region in which the maximum torque control can be performed, as compared to the structure that performs only the sine wave PWM control. When the necessary voltage of the motor is lower than the maximum output voltage, the sine wave PWM control or the overmodulation PWM control and the maximum torque control are performed. When the necessary voltage of the motor reaches the maximum output voltage, the square wave control and the weak field control are performed.

However, in the control device disclosed in JP-A-2006-311770, the PWM control is performed in the operation region in which the maximum torque control can be performed. However, in the PWM control, the number of times the switching elements of the inverter are turned on or off increases. As a result, a large switching loss is likely to occur. In order to further improve the efficiency of the motor, it is effective to prevent the switching loss. In the square wave control, it is possible to significantly reduce the number of times the switching elements are turned on or off, as compared to the PWM control. Therefore, it is possible to prevent the switching loss. JP-A-2008-079399 discloses a technique which determines a field adjustment command value in a direction in which the field flux of the AC motor is strengthened even in the operation region in which PWM control can be performed to maximize the modulation factor, thereby performing the square wave control (one-pulse driving). According to this technique, the amount of current flowing through the motor increases. In this case, the loss of the motor slightly increases, but it is possible to reduce the switching loss of the inverter. Therefore, it is possible to improve the overall efficiency of the system.

### SUMMARY OF THE INVENTION

However, during the square wave control, the modulation factor is maintained at the maximum value. Therefore, in the structure in which the square wave control and the PWM control are switched by the modulation factor, even when the operation state of the AC motor is changed, it is difficult to end the square wave control. Therefore, even when the rotational speed of the AC motor is reduced or the target torque is reduced, alone an increase in the field adjustment command value in the direction in which the field flux is strengthened is not sufficient to end the square wave control. Therefore, when the field adjustment command value increases, efficiency is reduced, or when square wave control is performed in the region in which the rotational speed is low, for example, oscillation is likely to occur in the output torque of the AC motor. However, JP-A-2008-079399 does not disclose a technique for appropriately ending the square wave control and the strong field control in the structure in which the square wave control is performed by the strong field control which strengthens the field flux.

Therefore, it is preferable to achieve a control device of a motor driving apparatus capable of appropriately ending the strong field control in the structure that performs the strong field control and the square wave control on the basis of a voltage index, such as the modulation factor.

### Means for Solving the Problem

In order to achieve the object, according to an aspect of the invention, there is provided a control device that controls a motor driving apparatus including a DC/AC conversion unit which converts a DC voltage into an AC voltage and supplies the AC voltage to an AC motor. The control device includes: a current command determining unit that determines a base current command value, which is a command value of a current supplied from the DC/AC conversion unit to the AC motor, on the basis of a target torque of the AC motor; a field adjusting unit that determines a field adjustment command value, which is an adjustment value of the base current command value; a voltage command determining unit that determines a voltage command value, which is a command value of a voltage supplied from the DC/AC conversion unit to the AC motor, on the basis of an adjusted current command value obtained by adjusting the base current command value with the field adjustment command value, and a rotational speed of the AC motor; and a voltage waveform control unit that controls the DC/AC conversion unit on the basis of the voltage command value to perform voltage waveform control including at least pulse width modulation control and square wave control; and a mode control unit that controls the field adjusting unit and the voltage waveform control unit. The voltage waveform control unit performs the pulse width modulation control when a voltage index indicating the magnitude of the voltage command value with respect to the DC voltage is less than a predetermined square wave threshold value, and performs the square wave control when the voltage index is equal to or greater than the square wave threshold value. The field adjusting unit is configured to perform field control including at least strong field control which determines the field adjustment command value such that the base current command value is adjusted to strengthen a field flux of the AC motor and normal field control which determines the field adjustment command value such that the base current command value is not adjusted, and performs the strong field control on the condition that the voltage index is equal to or greater than a predetermined strong field threshold value less than the square wave threshold value. The mode control unit ends the strong field control performed by the field adjusting unit on the condition that the field adjustment command value is equal to or greater than an adjustment command threshold value, which is determined on the basis of the target torque and a voltage/speed ratio indicating the ratio of the DC voltage to the rotational speed of the AC motor, in a direction in which the field flux is strengthened.

According to this structure, the strong field control is performed on the basis of the voltage index indicating the magnitude of the voltage command value with respect to the DC voltage. When the strong field control is performed, the voltage index increases to change the voltage waveform control to the square wave control. Therefore, it is possible to expand the operation region in which the square wave control of the AC motor is performed and reduce the switching loss of the DC/AC conversion unit. As a result, it is possible to improve efficiency. In addition, in this case, the field adjusting unit appropriately determines the field adjustment command value to change the intensity of the strong field. In this way, it is possible to appropriately output a torque corresponding to the target torque to the AC motor, regardless of the rotational speed of the AC motor. According to this structure, the strong field control ends on the condition that the field adjustment command value is equal to or greater than the adjustment command threshold value determined on the basis of the target torque and the voltage/speed ratio in the direction in which the field flux is strengthened. Therefore, it is possible to appropriately end the strong field control before efficiency is reduced due to an increase in the field adjustment command value. That is, it is possible to appropriately end the strong field control according to the relationship between an increase in the loss of the motor due to an increase in the field adjustment command value and a reduction in switching loss due to the execution of the square wave control. Therefore, it is possible to prevent a reduction in the overall efficiency of the system including the AC motor and the motor driving apparatus. In this case, it is possible to set an appropriate adjustment command threshold value corresponding to the target torque and the voltage/speed ratio using the adjustment command threshold value that is determined on the basis of the target torque and the voltage/speed ratio.

In a strong field/square wave control mode in which the strong field control and the square wave control are performed, when ending the strong field control, the mode control unit may gradually change the field adjustment command value in a direction in which the amount of adjustment of the field flux is reduced to gradually reduce the voltage index, thereby changing the control mode to a normal field/pulse width modulation control mode in which the normal field control and the pulse width modulation control are performed through a strong field/pulse width modulation control mode in which the strong field control and the pulse width modulation control are performed.

According to this structure, when the strong field control ends from the strong field/square wave control mode, the control mode is changed to the normal field/pulse width modulation control mode through the strong field/pulse width modulation control mode in which the strong field control and the pulse width modulation control are performed. Therefore, when the strong field control ends, it is possible to prevent a rapid change in the field adjustment command value and the voltage index. As a result, it is possible to prevent a rapid change in the current flowing through the coil of the AC motor or overshooting, and the occurrence of the oscillation of the output torque of the AC motor.

When the loss of the AC motor and the motor driving apparatus in a normal field/pulse width modulation control mode that performs the normal field control and the pulse width modulation control is a normal loss and the loss of the AC motor and the motor driving apparatus in a strong field/square wave control mode that performs the strong field control and the square wave control is a strong field loss, the upper limit of the range of the field adjustment command value in which the strong field loss is less than the normal loss in the direction in which the field flux is strengthened is the adjustment command threshold value.

According to this structure, it is possible to appropriately set the adjustment command threshold value such that the strong field control ends on the condition that the field adjustment command value is the upper limit of the range in which the strong field loss is less than the normal loss, that is, the range in which the loss in the strong field/square wave control mode is less than that in the normal field/pulse width modulation control mode, according to the strong field loss and the normal loss which vary depending on the target torque and the voltage/speed ratio, in this way, it is possible to end the strong field control when a reduction in efficiency due to an increase in the loss of the motor caused by an increase in the field adjustment command value is more than an increase in efficiency by a reduction in the switching loss due to the execution of the square wave control. Therefore, it is possible to maximize the effect of improving efficiency due to a reduction in the switching loss and improve the overall efficiency of the system including the AC motor and the motor driving apparatus.

The mode control unit may determine both a condition that the field adjustment command value is equal to or greater than the adjustment command threshold value and a condition that the rotational speed is less than a predetermined rotational speed threshold value, and end the strong field control when at least one of the conditions is satisfied.

According to this structure, the condition that the field adjustment command value is equal to or greater than the adjustment command threshold value and the condition that the rotational speed is less than the rotational speed threshold value are determined, and the strong field control ends when at least one of the conditions is satisfied. Therefore, it is possible to appropriately end the strong field control before the rotational speed of the AC motor is reduced to less than a rotational speed suitable to perform the square wave control. As a result, it is possible to prevent, for example, the occurrence of oscillation in the output torque of the AC motor by performing the square wave control in the region in which the rotational speed is low.

The rotational speed threshold value may be determined on the basis of the target torque and the DC voltage. According to this structure, it is possible to set an appropriate rotational speed threshold value corresponding to the target torque and the DC voltage.

The rotational speed where the voltage index is the strong field threshold value during the normal field control may be set as the rotational speed threshold value on the basis of the target torque and the DC voltage.

According to this structure, it is possible to appropriately set the rotational speed threshold value such that the strong field control ends on the condition that the voltage index is substantially less than the strong field threshold value, according to the voltage index varying depending on the target torque and the DC voltage, during the normal field control. In this way, it is possible to set the end condition of the strong field control so as to be identical to the start condition of the strong field control. In addition, it is possible to determine the end condition of the strong field control on the basis of the rotational speed corresponding to both the target torque and the DC voltage. Therefore, it is possible to easily and appropriately end the strong field control.

The mode control unit may control the field adjusting unit not to perform the strong field control when the target torque of the AC motor is beyond a predetermined strong field permissible torque range.

In the square wave control, the amount of harmonic components other than a fundamental wave component included in the current flowing through the coil is likely to increase. Therefore, in some cases, it is not suitable to perform the strong field control to change the control mode to the square wave control, depending on the target torque of the AC motor. According to this structure, since the torque range in which the strong field control is permitted is limited, it is possible to perform the strong field control only in the state in which a change to the square wave control is suitable and appropriately perform the square wave control.

When ending the strong field control, the mode control unit may control the field adjusting unit to change the field adjustment command value from the current value to zero at a constant rate of change.

According to this structure, when the strong field control ends, the field adjustment command value is changed so as to be reduced to zero at a constant rate of change. Therefore, it is possible to gradually reduce the voltage index. In this way, while the voltage index is gradually reduced from the square wave threshold value, it is possible to appropriately perform the strong field/pulse width modulation control mode. Therefore, it is possible to prevent a rapid change in the field adjustment command value and the voltage index when the strong field control ends. As a result, it is possible to prevent a rapid change in the current flowing through the coil of the AC motor or overshooting, and the occurrence of oscillation of the output torque of the AC motor.

The voltage command determining unit may perform feedback control on the adjusted current command value on the basis of an actual current value, which is the actual value of the current supplied from the DC/AC conversion unit to the AC motor, thereby determining the voltage command value.

According to this structure, current feedback control is performed on the basis of the deviation between the actual current value detected by, for example, a current sensor and the current command value adjusted with the field adjustment command value to perform appropriately determine the voltage command value.

### BRIEF DESCRIPTION OF THE DRAWINGS

FIG. 1 is a circuit diagram illustrating the structure of a motor driving apparatus according to an embodiment of the invention;

FIG. 2 is a functional block diagram illustrating a control device according to the embodiment of the invention;

FIG. 3 is a diagram illustrating an example of a voltage control area map according to the embodiment of the invention;

FIG. 4 is a diagram illustrating an example of a base d-axis current command value map according to the embodiment of the invention;

FIG. 5 is a diagram illustrating an example of a q-axis current command value map according to the embodiment of the invention;

FIG. 6 is a diagram illustrating an example of a conversion map used in an integral input adjusting unit according to the embodiment of the invention;

FIGS. 7A to 7C are conceptual diagrams illustrating a method of calculating a rotational speed threshold value according to the embodiment of the invention;

FIGS. 8A to 8C are conceptual diagrams illustrating a method of calculating an adjustment command threshold value according to the embodiment of the invention;

FIG. 9 is a flowchart illustrating the flow of the operation of the control device according to the embodiment of the invention; and

FIGS. 10A to 10C are diagrams illustrating an example of a change in a d-axis current command value and a q-axis current command value due to a change in a target torque and a rotational speed in the control device according to the embodiment of the invention.

### DETAILED DESCRIPTION OF THE PREFERRED EMBODIMENT

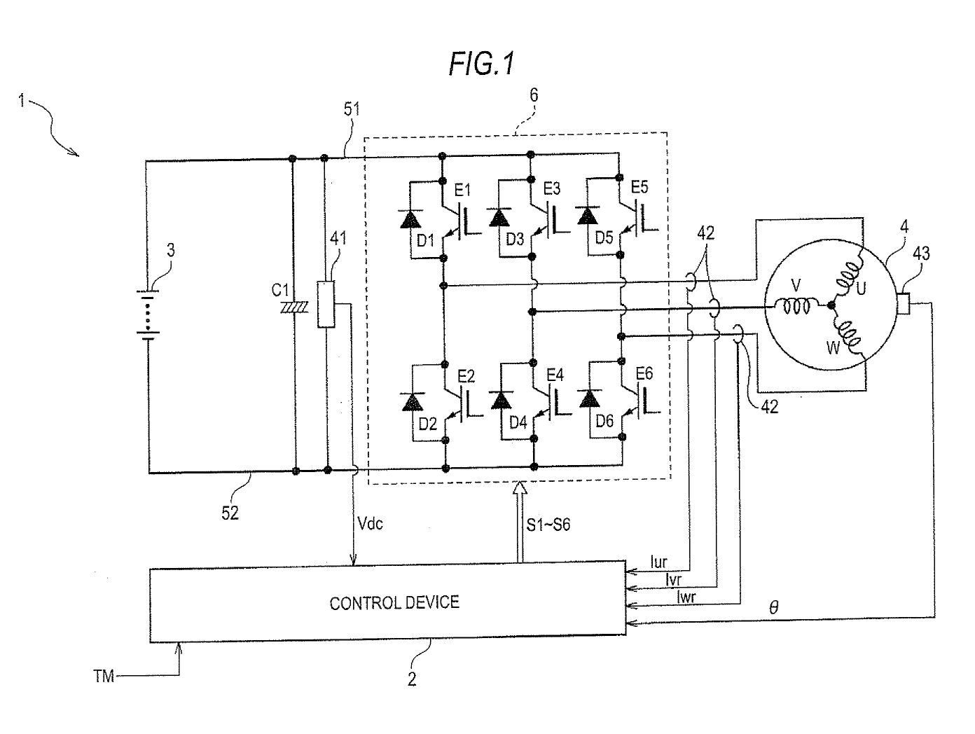

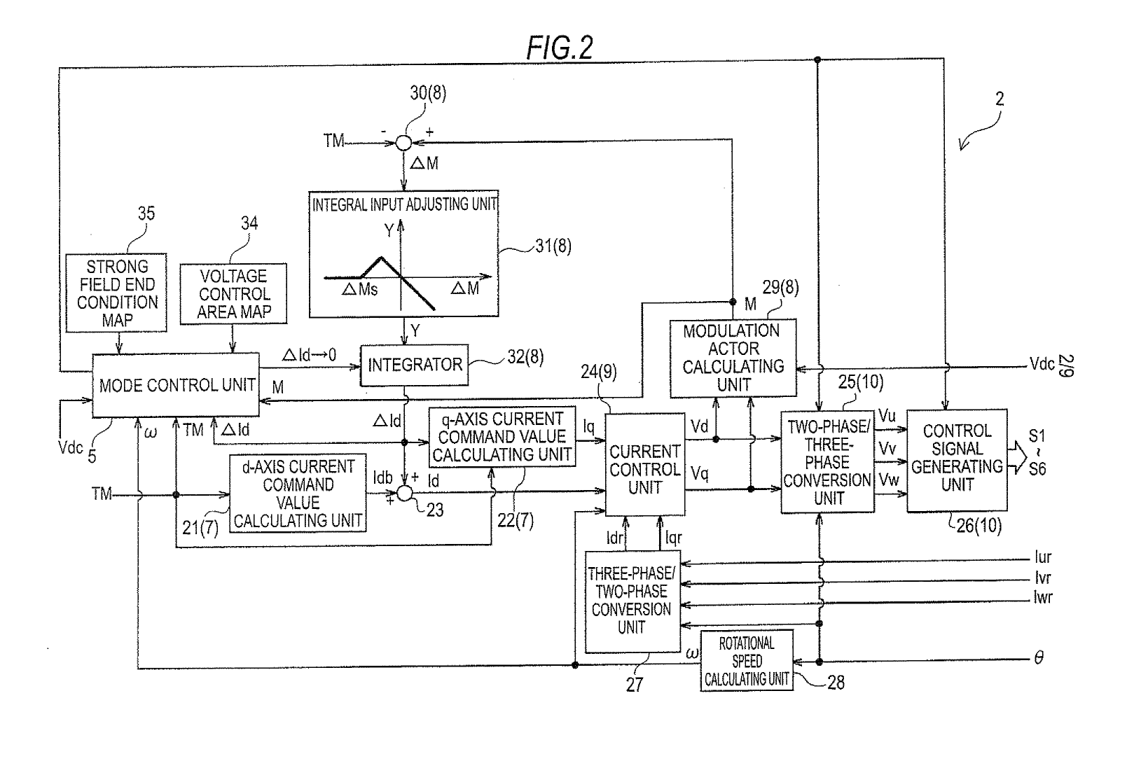

First, exemplary embodiments of the invention will be described with reference to the accompanying drawings. As shown in FIG. 1, in this embodiment, a case in which a motor driving apparatus 1 drives an interior permanent magnet synchronous motor 4 (IPMSM: hereinafter, simply referred to as a “motor 4”), which is an AC motor operated by a three-phase AC, will be described as an example. The motor 4 is configured so as to be operated as a power generator, if necessary. The motor 4 is used as a driving force source for, for example, an electric vehicle or a hybrid vehicle. The motor driving apparatus 1 includes an inverter 6 that converts a DC voltage Vdc into an AC voltage and supplies the AC voltage to the motor 4. In this embodiment, as shown in FIG. 2, a control device 2 controls the motor driving apparatus 1 to perform current feedback control on the motor 4 using a vector control method. In this case, the control device 2 can perform pulse width modulation (hereinafter, referred to as “PWM”) control and square wave control as voltage waveform control. In addition, the control device 2 can perform, as field adjustment control, normal field control that does not adjust base current command values Idb and Iqb determined on the basis of target torque TM, weak field control that adjusts the base current command values Idb and Iqb such that the field flux of the motor 4 is weakened, and strong field control that adjusts the base current command values Idb and Iqb such that the field flux of the motor 4 is strengthened. The control device 2 is characterized in that it is configured to appropriately end the strong field control according to the operation conditions of the motor 4 in a structure in which the strong field control and square wave control are performed on the basis of a modulation factor M, which is a voltage index. Next, the motor driving apparatus 1 and the control device 2 of the motor driving apparatus 1 according to this embodiment will be described in detail.

### 1. Structure of Motor Driving Apparatus

First, the structure of the motor driving apparatus 1 according to this embodiment will be described with reference to FIG. 1. The motor driving apparatus 1 includes the inverter 6 that converts the DC voltage Vdc into an AC voltage and supplies the AC voltage to the motor 4. In addition, the motor driving apparatus 1 includes a DC power supply 3 that generates the DC voltage Vdc and a smoothing capacitor C1 that smoothes the DC voltage Vdc from the DC power supply 3. For example, various kinds of secondary batteries, such as a nickel-hydride secondary battery and a lithium-ion secondary battery, capacitors, a combination thereof may be used as the DC power supply 3. The DC voltage Vdc, which is the voltage of the DC power supply 3, is detected by a voltage sensor 41 and is output to the control device 2.

The inverter 6 is a device for converting the DC voltage Vdc into an AC voltage and supplying the AC voltage to the motor 4 and corresponds to a DC/AC conversion unit according to the invention. The inverter 6 includes a plurality of sets of switching elements E1 to E6 and diodes D1 to D6. The inverter 6 includes a pair of switching elements for each phase (three phases, such as a U phase, a V phase, and a W phase) of the motor 4, specifically, a pair of an upper arm element E1 for a U phase and a lower arm element E2 for a U phase, a pair of an upper arm element E3 for a V phase and a lower arm element E4 for a V phase, and a pair of an upper arm element E5 for a W phase and a lower arm element E6 for a W phase. In this example, IGBTs (insulated gate bipolar transistors) are used as the switching elements E1 to E6. The emitters of the upper arm elements E1, E3, and E5 for each phase and the collectors of the lower arm elements E2, E4, and E6 for each phase are connected to coils for each phase of the motor 4. The collectors of the upper arm elements E1, E3, and E5 for each phase are connected to a system voltage line 51, and the emitters of the lower arm elements E2, E4, and E6 for each phase is connected to a negative line 52. In addition, the diodes D1 to D6 serving as free-wheel diodes are connected in parallel to the switching elements E1 to E6. Various kinds of power transistors, such as bipolar transistors, field effect transistors, and MOS transistors, other than the IGBTs may be used as the switching elements E1 to E6.

The switching elements E1 to E6 are turned on or off by switching control signals S1 to S6 output from the control device 2, respectively. In this way, the inverter 6 converts the DC voltage Vdc into an AC voltage and supplies the AC voltage to the motor 4 such that the motor 4 outputs torque corresponding to a target torque TM. In this case, each of the switching elements E1 to E6 performs a switching operation corresponding to PWM control or square wave control, which will be described below, in response to the switching control signals S1 to S6. In this embodiment, the switching control signals S1 to 56 are gate driving signals for driving the gates of the switching elements E1 to E6. When the motor 4 functions as a power generator, the inverter 6 converts the generated AC voltage into a DC voltage and supplies the DC voltage to the system voltage line 51. Currents corresponding to each phase flowing through the coils for each phase of the motor 4, specifically, a U-phase current Iur, a V-phase current Ivr, and a W-phase current Iwr are detected by a current sensor 42 and are output to the control device 2.

The magnetic pole position θ of a rotor of the motor 4 at each point of time is detected by a rotation sensor 43 and is output to the control device 2. The rotation sensor 43 is, for example, a resolver. The magnetic pole position θ indicates the rotational angle of the rotor on the electric angle. The target torque TM of the motor 4 is input as a request signal from another control device (not shown), such as a vehicle control device, to the control device 2. That is, the target torque TM is a command value (torque command value) of the output torque from the motor 4.

### 2. Structure of Control Device

Next, the structure of the control device 2 shown in FIG. 1 will be described in detail with reference to FIGS. 2 to 7C. In the following description, each functional unit of the control device 2 is formed by hardware or/and software (program) for performing various kinds of processes on input data, using a logic circuit, such as a microcomputer, as a core member. As described above, the target torque TM and the magnetic pole position θ are input to the control device 2. In addition, the U-phase current Iur, the V-phase current Ivr, and the W-phase current Iwr are input to the control device 2. As shown in FIG. 2, the control device 2 performs current feedback control using a vector control method on the basis of the target torque TM, the magnetic pole position θ, the rotational speed ω of the motor 4 calculated from the magnetic pole position θ, and the three phase currents Iur, Ivr, and Iwr, thereby determining voltage command values Vd and Vq, which are the command values of the voltage supplied to the motor 4. The control device 2 generates the switching control signals S1 to S6 for driving the inverter 6 on the basis of the voltage command values Vd and Vq and outputs the generated switching control signals S1 to S6 to control the driving of the motor 4 through the inverter 6.

### 2-1. Control Mode

In this embodiment, the control device 2 can perform PWM control and square wave control as the voltage waveform control that controls the inverter 6 on the basis of the voltage command values Vd and Vq. In addition, the control device 2 can perform normal field control, strong field control; and weak field control as the field control that determines a d-axis current adjustment command value Aid serving as a field adjustment command value with respect to base current command values Idb and Iqb, thereby adjusting the field flux of the motor 4. The control device 2 selectively performs any one of a plurality of control modes by a combination of the voltage waveform control and the field control.

In the PWM control, the turning-on or off of each of the switching elements E1 to E6 of the inverter 6 is controlled on the basis of three-phase AC voltages Vu, Vv, and Vw based on the voltage command values Vd and Vq (see FIG. 2). Specifically, the duty ratio of each pulse is controlled such that PWM waveforms, which are U, V, and W-phase voltage waveforms output from the inverter 6, are a set of pulses having a high-level period for which the upper arm elements E1, E3, and E5 are turned on and a low-level period for which the lower arm elements E2, E4, and E6 are turned on and a fundamental wave component of the PWM waveform has a substantially sine wave shape for a predetermined period. In this embodiment, the PWM control includes two control methods, such as normal PWM control and overmodulation PWM control.

The normal PWM control is PWM control in which the amplitudes of the AC voltage waveforms Vu, Vv, and Vw are less than that of a carrier waveform. Sine wave PWM control is a representative example of the normal PWM control. In this embodiment, space vector PWM (hereinafter, referred to as “SVPWM”) control is used which applies a neutral bias voltage to the fundamental wave of each phase in the sine wave PWM control. In the SVPWM control, a PWM waveform is directly generated by a digital operation without comparison with the carrier. In this case, the amplitudes of the AC voltage waveforms Vu, Vv, and Vw are also less than that of a virtual carrier waveform. In the invention, it is assumed that the control method that generates the PWM waveform without using a carrier is also included in the normal PWM control or the overmodulation PWM control since the amplitude of the PWM waveform is compared with that of the virtual carrier waveform. When the ratio of the effective value of the fundamental wave component of the voltage waveform output from the inverter 6 with respect to the DC voltage Vdc is a modulation factor M (see Formula (4) which will be described below), the modulation factor M can be changed in the range of “0 to 0.707” in the SVPWM control serving as the normal PWM control.

The overmodulation PWM control is PWM control in which the amplitudes of the AC voltage waveforms Vu, Vv, and Vw are more than that of the carrier waveform (triangular wave). In the overmodulation PWM control, the duty ratio of each pulse is high in the mountain portion of the fundamental wave component of each pulse and is low in the valley portion of the fundamental wave component, as compared to the normal PWM control, thereby distorting the waveform of the fundamental wave component of the voltage waveform output from the inverter 6 such that the amplitude is more than that in the normal PWM control. In the overmodulation PWM control, the modulation factor M can be changed in the range of “0.707 to 0.78”.

The square wave control is rotation synchronization control in which the switching elements E1 to E6 are turned on and off once for one period of the electric angle of the motor 4 and the pulse of each phase is output once for half of the period of the electric angle. That is, the square wave control is performed such that the U, V, and W-phase voltage waveforms output from the inverter 6 become square waves in which the high level period and the low level period appear alternately for one period and the ratio of the high level period to the low level period is 1:1. In this case, the output voltage waveforms of each phase are output with a phase difference of 120° therebetween. In this way, in the square wave control, a voltage with a square wave shape is output to the inverter 6. In the square wave control, the modulation factor M is fixed to “0.78”, which is a maximum modulation factor Mmax. That is, when the modulation factor M reaches the maximum modulation factor Mmax, the square wave control is performed. Therefore, in this embodiment, a square wave threshold value Mb, which is the threshold value of the modulation factor M for performing the square wave control, is set to the maximum modulation factor Mmax.

As described above, the field control according to this embodiment includes the normal field control, the strong field control, and the weak field control. A current command determining unit 7 determines base current command values Idb and Iqb, which are the command values of the current supplied from the inverter 6 to the motor 4, on the basis of the target torque TM of the motor 4, which will be described below. In the field control, the field flux of the motor 4 is adjusted by a field adjustment command value (d-axis current adjustment command value ΔId) for adjusting the determined base current command values Idb and Iqb. Specifically, the current command determining unit 7 determines the base d-axis current command value Idb and the base q-axis current command value Iqb as the base current command values on the basis of the target torque TM. In a current vector control method, the d-axis is set to the flux direction of the field and the q-axis is set to a direction that leads the direction of the field by an electric angle of π/2. Therefore, it is possible to adjust the field flux of the motor 4 by appropriately determining the d-axis current adjustment command value ΔId for adjusting the base d-axis current command value Idb as the field adjustment command value.

The current command determining unit 7 determines the base current command values Idb and Iqb such that the maximum torque control is performed, which will be described below. The maximum torque control adjusts the phase of the current such that the output torque of the motor 4 is the maximum for the same current. In the maximum torque control, it is possible to most effectively generate torque for the current flowing through the armature coil of the motor 4. The phase of the current is a phase with respect to the q-axis of the resultant vector of the d-axis current command value and the q-axis current command value. The normal field control is field control in which the base current command values Idb and Iqb determined by the current command determining unit 7 are not adjusted. That is, in the normal field control, the d-axis current adjustment command value ΔId is set to zero (ΔId=0) such that the base d-axis current command value Idb is not adjusted. Therefore, in this embodiment, the control device 2 performs the maximum torque control while the normal field control is performed. In other words, the normal field control according to this embodiment is the maximum torque control.

The strong field control is field control that adjusts the base current command values Idb and Iqb such that the field flux of the motor 4 is stronger than that in the normal field control (maximum torque control). That is, in the strong field control, the phase of the current is adjusted such that a magnetic flux is generated from the armature coil in a direction in which the field flux of the motor 4 is strengthened. In the strong field control, the d-axis current adjustment command value ΔId is set such that the phase of the current lags that in the normal field control. Specifically, in the strong field control, the d-axis current adjustment command value ΔId is set to a positive value (ΔId>0) such that the base d-axis current command value Idb is changed in the positive direction (increases).

The weak field control is field control that adjusts the base current command values Idb and Iqb such that the field flux of the motor 4 is weaker than that in the normal field control (maximum torque control). That is, in the weak field control, the phase of the current is adjusted such that a magnetic flux is generated from the armature coil in a direction in which the field flux of the motor 4 is weakened. In the weak field control, the d-axis current adjustment command value ΔId is set such that the phase of the current leads that in the normal field control. Specifically, in the weak field control, the d-axis current adjustment command value ΔId is set to a negative value (ΔId<0) such that the base d-axis current command value Idb is changed in the negative direction (decreases).

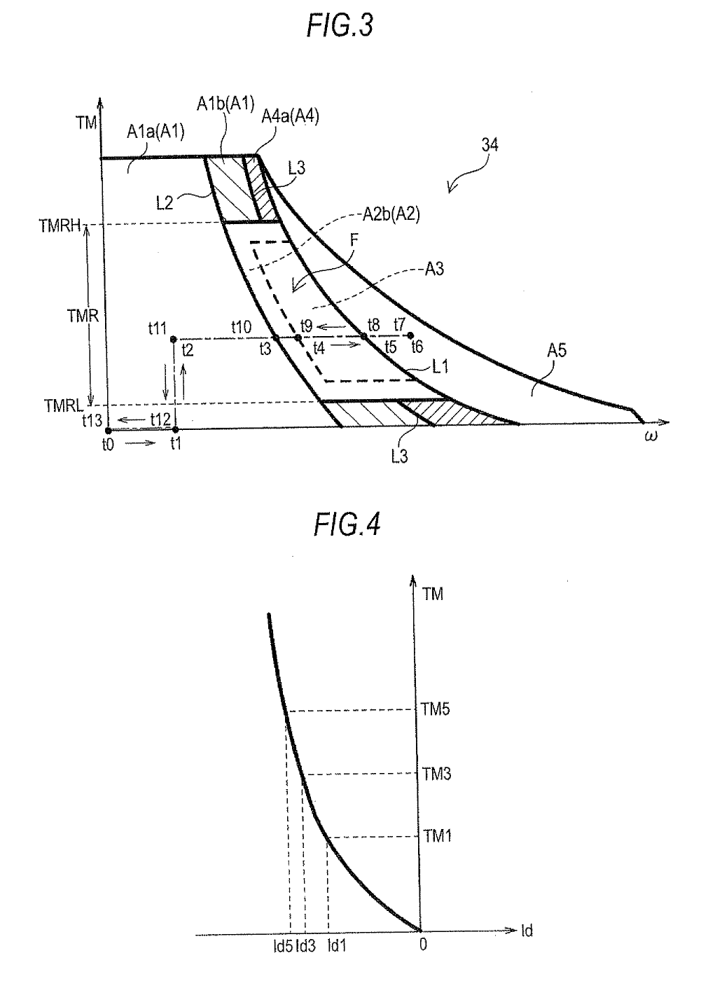

FIG. 3 is a diagram illustrating an example of a voltage control area map 34 (see FIG. 2) defining regions in which each control mode is performed in the operable range of the motor 4 defined by the rotational speed ω and the target torque TM. As shown in FIG. 3, in this embodiment, the control device 2 is configured to perform a normal field/PWM control mode A1 that performs the normal field control and the PWM control, a strong field/PWM control mode A2 that performs the strong field control and the PWM control, a strong field/square wave control mode A3 that performs the strong field control and the square wave control, and a weak field/square wave control mode A5 that performs the weak field control and the square wave control. In addition, the control device 2 is configured to perform a weak field/PWM control mode A4 that performs the weak field control and the PWM control between the normal field/PWM control mode A1 and the weak field/square wave control mode A5 when the control mode is changed to the weak field/square wave control mode A5 without passing through the strong field/PWM control mode A2 and the strong field/square wave control mode A3. In the map shown in FIG. 3, an area F is a strong field control area in which the strong field control is performed. In the strong field control area F, the strong field/square wave control mode A3 is performed basically. However, when the control mode is changed between the strong field/square wave control mode A3 and another mode, the strong field/PWM control mode A2 is performed.

As described above, in this embodiment, two voltage waveform control methods, that is, the normal PWM control and the overmodulation PWM control are performed as the PWM control. Therefore, the normal field/PWM control mode A1 includes a normal field/normal PWM control mode A1 a that performs the normal field control and the normal PWM control and a normal field/overmodulation PWM control mode A1b that performs the normal field control and the overmodulation PWM control. The strong field/PWM control mode A2 includes a strong field/overmodulation PWM control mode A2b that performs the strong field control and the overmodulation PWM control. The weak field/PWM control mode A4 includes a weak field/overmodulation PWM control mode A4a that performs the weak field control and the overmodulation PWM control.

In the example of the voltage control area shown in FIG. 3, curves L1 to L3 are all determined by the rotational speed ω and the target torque TM of the motor 4 when the modulation factor M has a given value during the normal field control (maximum torque control). The curve L1 is formed when the modulation factor M is the maximum modulation factor Mmax (=0.78) during the normal field control. The curve L2 is formed when the modulation factor M is an overmodulation threshold value Mo (=0.707) set to the boundary value between the normal PWM control and the overmodulation PWM control during the normal field control. In this embodiment, a strong field threshold value Ms, which will be described below, is set so as to be equal to the overmodulation threshold value Mo. The curve L3 is formed when the modulation factor M is a value (for example, 0.76) set between the overmodulation threshold value Mo and the maximum modulation factor Mmax during the normal field control.

However, as the rotational speed ω of the motor 4 increases, an induced voltage thereof increases, and an AC voltage (hereinafter, referred to as a “necessary voltage”) required to drive the motor 4 increases. When the necessary voltage is higher than the maximum AC voltage (hereinafter, referred to as a “maximum output voltage”) that can be converted from the DC voltage Vdc and output from the inverter 6, it is difficult to make the necessary current flow through the coil and thus appropriately control the motor 4. Therefore, in a region close to the high rotation side than the curve L1 where the modulation factor M indicating the necessary voltage of the motor 4 with respect to the maximum output voltage based on the DC voltage Vdc reaches the maximum modulation factor Mmax, the weak field/square wave control mode A5 is performed. The necessary voltage and the maximum output voltage can be compared with each other as the effective values of the AC voltage.

In this embodiment, when the modulation factor M is less than the maximum modulation factor Mmax but predetermined conditions are satisfied, the strong field/square wave control mode A3 performing the strong field control and the square wave control is performed. In addition, when the control mode is changed between the strong field/square wave control mode A3 and another mode, the strong field/PWM control mode A2 is performed in order to prevent a rapid change in the adjusted current command values Id and Iq. In this way, it is possible to prevent a rapid change in the current flowing through the coil of the motor 4 or overshooting, and the oscillation of the output torque of the motor 4. When the normal field control is performed, it is possible to perform the square wave control while outputting torque corresponding to the target torque TM to the motor 4 by performing the strong field control, with the modulation factor M being less than the maximum modulation factor Mmax.

As shown in FIG. 3, the strong field control area F is set in a strong field permissible torque range TMR defined for the target torque TM. That is, the strong field control area F is set to a region (Ms≦M<Mmax) in which the modulation factor M is from the strong field threshold value Ms (which is equal to the overmodulation threshold value Mo; curve L2) to the maximum modulation factor Mmax (curve L1) during the normal field control in the strong field permissible torque range TMR. When an operating point determined by the rotational speed ω and the target torque TM of the motor 4 is moved from the region of the normal field/PWM control mode A1 into the strong field control area F, the control device 2 performs control to change the control mode from the normal field/PWM control mode A1 to the strong field/square wave control mode A3 through the strong field/PWM control mode A2. On the contrary, when the operating point of the motor 4 is moved from the strong field control area F into the region of the normal field/PWM control mode A1, the control device 2 performs control to change the control mode from the strong field/square wave control mode A3 to the normal field/PWM control mode A1 through the strong field/PWM control mode A2. When the operating point of the motor 4 remains in the strong field control area F, the strong field/square wave control mode A3 is continuously performed. When the strong field control area F is set in this way, it is possible to expand the region in which the square wave control is performed in the operable region of the motor 4, as compared to the related art including only the weak field/square wave control mode A5. In FIG. 3, a dashed line partitioning the strong field control area F indicates an example of the boundary between the region in which the strong field/PWM control mode A2 is performed and the region in which the strong field/square wave control mode A3 is performed when the rotational speed ω or the target torque TM of the motor 4 are changed at a predetermined speed. The position of the boundary depends on the rate of change in the rotational speed ω or the target torque TM.

In a region closer to the low rotation side than the curve L2, the normal field/normal PWM control mode A1a is performed. In the range other than the strong field permissible torque range TMR, in a region that is closer to the high rotation side than the curve L2 and is closer to the low rotation side than the curve L3, the normal field/overmodulation PWM control mode A1b is performed. In the range other than the strong field permissible torque range TMR, in a region that is closer to the high rotation side than the curve L3 and is closer to the low rotation side than the curve L1, the weak field/overmodulation PWM control mode A4a (weak field/PWM control mode A4) is performed. When the control mode is rapidly changed from the normal field/overmodulation PWM control mode A1b to the state (weak field/square wave control mode A5) in which the weak field control and the square wave control are performed, the adjusted current command values Id and Iq are rapidly changed. However, the weak field/overmodulation PWM control mode A4a is performed to prevent the rapid change in the adjusted current command values Id and Iq.

### 2-2. Functional Units of Control Device

Next, each functional unit of the control device 2 will be described with reference to a functional block diagram of FIG. 2 showing the control device 2. As shown in FIG. 2, the target torque TM is input to a d-axis current command value calculating unit 21. The d-axis current command value calculating unit 21 calculates the base d-axis current command value Idb on the basis of the input target torque TM. The base d-axis current command value Idb corresponds to the command value of a d-axis current when the maximum torque control is performed. In this embodiment, the d-axis current command value calculating unit 21 calculates the base d-axis current command value Idb corresponding to the value of the target torque TM using a base d-axis current command value map shown in FIG. 4. In the example shown in FIG. 4, when the value of “TM1” is input as the target torque TM, the d-axis current command value calculating unit 21 calculates “Id1” as the base d-axis current command value Idb. Similarly, when the values of “TM3” and “TM5” are input as the target torque TM, the d-axis current command value calculating unit 21 calculates “Id3” and “Id5” as the base d-axis current command value Idb. The calculated base d-axis current command value Idb is input to an adder 23. The d-axis current adjustment command value ΔId calculated by an integrator 32, which will be described below, is also input to the adder 23. The adder 23 adds the d-axis current adjustment command value ΔId to the base d-axis current command value Idb to calculate an adjusted d-axis current command value Id, as represented by the following Formula (1):

Id=Idb+ΔId (1)

The target torque TM and the d-axis current adjustment command value ΔId are input to a q-axis current command value calculating unit 22. The q-axis current command value calculating unit 22 calculates an adjusted q-axis current command value Iq on the basis of the input target torque TM and d-axis current adjustment command value ΔId. In this embodiment, the q-axis current command value calculating unit 22 calculates the adjusted q-axis current command value Iq corresponding to the target torque TM and the d-axis current adjustment command value ΔId using a q-axis current command value map shown in FIG. 5. In FIG. 5, the thin solid line is an equal torque line 61 indicating a combination of the d-axis current and the q-axis current for outputting the torques TM1 to TM5, and the thick solid line is a maximum torque control line 62 indicating the values of the d-axis current and the q-axis current for performing the maximum torque control. In FIG. 5, the thick one-dot chain line is a voltage limit ellipse 63 indicating the range of a value capable of obtaining the d-axis current and the q-axis current limited by the rotational speed ω and the DC voltage Vdc of the motor 4. The diameter of the voltage limit ellipse 63 is inversely proportional to the rotational speed ω of the motor 4 and is proportional to the DC voltage Vdc. When the adjusted d-axis current command value Id and the adjusted q-axis current command value Iq are on the voltage limit ellipse 63, the modulation factor M is the maximum modulation factor Mmax (=0.78). In this case, the control device 2 controls the voltage waveform control unit 10 to perform the square wave control. In the hatched strong field control area F in FIG. 5, the strong field/PWM control mode A2 and the strong field/square wave control mode A3 are performed. The upper limit of the strong field control area F is defined by an intersection point between the maximum torque control line 62 and the voltage limit ellipse 63. The strong field control starts when the modulation factor M in the normal field control is the strong field threshold value Ms and ends when predetermined strong field end conditions are satisfied, which will be described below. Therefore, the lower limit of the strong field control area F is defined by the strong field threshold value Ms and the strong field end conditions.

In the example shown in FIG. 5, when the value of “TM1” is input as the target torque TM, the q-axis current command value calculating unit 22 calculates “Iq1”, which is the value of the q-axis current at an intersection point between the equal torque line 61 of the target torque TM=TM1 and the maximum torque control line 62, as the base q-axis current command value Iqb. The base q-axis current command value corresponds to the command value of the q-axis current when the maximum torque control is performed. In this case, neither the weak field control nor the strong field control is performed, and the d-axis current adjustment command value ΔId input from the integrator 32, which will be described below, is zero (ΔId=0). Therefore, the adjusted q-axis current command value Iq is equal to the base q-axis current command value Iqb. In this case, the control device 2 performs the normal field/PWM control mode A1.

When the value of “TM3” is input as the target torque TM, the q-axis current command value calculating unit 22 calculates “Iq3”, which is the value of the q-axis current at an intersection point between the equal torque line 61 of the target torque TM=TM3 and the maximum torque control line 62, as the base q-axis current command value Iqb. At that time, since the base d-axis current command value Idb and the base q-axis current command value Iqb are within the strong field control area F, the strong field control is performed. In this case, a positive value is input as the d-axis current adjustment command value ΔId from the integrator 32, which will be described below. In this embodiment, “ΔId1” (ΔId1>0) is input as the d-axis current adjustment command value ΔId. Therefore, the q-axis current command value calculating unit 22 calculates “Iq4”, which is the value of the q-axis current on the voltage limit ellipse 63 that is moved by “ΔId1” in the positive direction of the d-axis along the equal torque line 61 of the target torque TM=TM3, as the adjusted q-axis current command value Iq. In this case, the control device 2 performs the strong field/square wave control mode A3.

When the value of “TM5” is input as the target torque TM, the q-axis current command value calculating unit 22 calculates “Iq5”, which is the value of the q-axis current at an intersection point between the equal torque line 61 of the target torque TM=TM5 and the maximum torque control line 62, as the base q-axis current command value Iqb. At that time, since the base d-axis current command value Idb and the base q-axis current command value Iqb are outside the voltage limit ellipse 63, the weak field control is performed. In this case, a negative value is input as the d-axis current adjustment command value ΔId from the integrator 32, which will be described below. In this embodiment, “−ΔId2” (−ΔId2<0) is input as the d-axis current adjustment command value ΔId. Therefore, the q-axis current command value calculating unit 22 calculates “Iq6”, which is the value of the q-axis current on the voltage limit ellipse 63 that is moved by “−ΔId2 in the negative direction of the d-axis along the equal torque line 61 of the target torque TM=TM5, as the adjusted q-axis current command value Iq. In this case, the control device 2 performs the weak field/square wave control mode A5.

The values (Id1, Id3, and Id5) of the d-axis current corresponding to the base q-axis current command values Iqb (Iq1, Iq3, and Iq5) calculated using the q-axis current command value map shown in FIG. 5 are equal to the base d-axis current command values Idb calculated using the base d-axis current command value map shown in FIG. 4. Therefore, the base d-axis current command value Idb can be calculated by the map shown in FIG. 5. In this embodiment, the d-axis current command value calculating unit 21 and the q-axis current command value calculating unit 22 that determine the base d-axis current command value Idb and the base q-axis current command value Iqb on the basis of the target torque TM of the motor 4 form the current command determining unit 7 according to the invention. The base d-axis current command value Idb and the base q-axis current command value Iqb are base current command values according to the invention, which are the command values of the current supplied from the inverter 6 to the motor 4.

The adjusted d-axis current command value Id and the adjusted q-axis current command value Iq calculated in the above-mentioned way are input to a current control unit 24. In addition, the actual d-axis current Idr and the actual q-axis current Iqr from the three-phase/two-phase conversion unit 27 and the rotational speed e of the motor 4 from the rotational speed calculating unit 28 are input to the current control unit 24. The actual d-axis current Idr and the actual q-axis current Iqr correspond to the actual values of the current supplied from the inverter 6 to the motor 4 and are calculated by a three-phase/two-phase conversion unit 27 to perform three-phase/two-phase conversion on the basis of the U-phase current Iur, the V-phase current Ivr, and the W-phase current Iwr detected by the current sensor 42 (see FIG. 1) and the magnetic pole position θ detected by the rotation sensor 43 (see FIG. 1). In addition, a rotational speed calculating unit 28 calculates the rotational speed ω of the motor 4 on the basis of the magnetic pole position 8 detected by the rotation sensor 43 (see FIG. 1).

The current control unit 24 performs feedback control on the adjusted d-axis current command value Id and the adjusted q-axis current command value Iq on the basis of the actual d-axis current Idr and the actual q-axis current Iqr to determine the voltage command values Vd and Vq. For this, the current control unit 24 calculates a d-axis current deviation δId, which is the deviation between the adjusted d-axis current command value Id and the actual d-axis current Idr, and a q-axis current deviation δIq, which is the deviation between the adjusted q-axis current command value Iq and the actual q-axis current Iqr. Then, the current control unit 24 performs a proportional-plus-integral control operation (PI control operation) on the basis of the d-axis current deviation δId to calculate a base d-axis voltage command value Vzd, and performs the proportional-plus-integral control operation on the basis of the q-axis current deviation δIq to calculate a base q-axis voltage command value Vzq. In addition, a proportional-plus-integral-plus-derivative control operation (PID control operation) may be performed instead of the proportional-plus-integral control operation.

Then, the current control unit 24 performs adjustment to subtract a q-axis armature reaction Eq from the base d-axis voltage command value Vzd, thereby calculating a d-axis voltage command value Vd, as represented by the following Formula (2):

$$\begin{matrix}Vd = Vzd - Eq \\ = Vzd - ω \cdot Lq \cdot Iqr\end{matrix} \qquad ( 2 )$$

As represented by Formula (2), the q-axis armature reaction Eq is calculated on the basis of the rotational speed ω of the motor 4, the actual q-axis current Iqr, and the q-axis inductance Lq.

In addition, the current control unit 24 performs adjustment to add the d-axis armature reaction Ed and a voltage Em inducted by the armature interlinkage magnetic flux of the permanent magnet to the base q-axis voltage command value Vzq, thereby calculating a q-axis voltage command value Vq, as represented by the following Formula (3):

$$\begin{matrix}Vq = Vzq + Ed + Em \\ = Vzq + ω \cdot Ld \cdot Idr + ω \cdot MIf\end{matrix} \qquad ( 3 )$$

As represented by Formula (3), the d-axis armature reaction Ed is calculated on the basis of the rotational speed ω of the motor 4, the actual d-axis current Idr, and the d-axis inductance Ld. In addition, the induced voltage Em is calculated on the basis of the induced voltage constant MIf determined by the effective value of the armature interlinkage magnetic flux of the permanent magnet and the rotational speed ω of the motor 4.

In this embodiment, the d-axis voltage command value Vd and the q-axis voltage command value Vq correspond to the voltage command value according to the invention. Then, the voltage command values Vd and Vq are determined on the basis of the adjusted current command values Id and Iq obtained by performing field adjustment on the base current command values Idb and Iqb using the d-axis current adjustment command value ΔId, the rotational speed ω of the motor 4, the actual d-axis current Idr, and the actual q-axis current Iqr. Therefore, the current control unit 24 forms a voltage command determining unit 9 according to the invention.

The voltage waveform control unit 10 controls the inverter 6 on the basis of the voltage command values Vd and Vq to perform voltage waveform control including at least the PWM control and the square wave control. In this embodiment, the voltage waveform control unit 10 selectively performs any one of the normal PWM control, the overmodulation PWM control, and the square wave control. In this embodiment, the voltage waveform control unit 10 performs the square wave control in response to a command from a mode control unit 5, which will be described below, when the modulation factor M is equal to or greater than the square wave threshold value Mb (=0.78). When the modulation factor M is less than the square wave threshold value Mb, the voltage waveform control unit 10 performs the normal PWM control or the overmodulation PWM control on the basis of the overmodulation threshold value Mo (=0.707). The voltage waveform control unit 10 includes a two-phase/three-phase conversion unit 25 and a control signal generating unit 26.

The d-axis voltage command value Vd and the q-axis voltage command value Vq are input to the two-phase/three-phase conversion unit 25. In addition, the magnetic pole position θ detected by the rotation sensor 43 (see FIG. 1) is input to the two-phase/three-phase conversion unit 25. The two-phase/three-phase conversion unit 25 performs two-phase/three-phase conversion on the d-axis voltage command value Vd and the q-axis voltage command value Vq using the magnetic pole position θ to calculate three-phase AC voltage command values, that is, a U-phase voltage command value Vu, a V-phase voltage command value Vv, and a W-phase voltage command value Vw. However, since the AC voltage command values Vu, Vv, and Vw have different waveforms in each control mode, the two-phase/three-phase conversion unit 25 outputs the AC voltage command values Vu, Vv, and Vw with different voltage waveforms in each control mode to the control signal generating unit 26. Specifically, when receiving a command to perform the normal PWM control from the mode control unit 5, which will be described below, the two-phase/three-phase conversion unit 25 outputs the AC voltage command values Vu, Vv, and Vw with an AC voltage waveform corresponding to the normal PWM control. In this embodiment, since the normal PWM control is SVPWM control, the AC voltage command values Vu, Vv, and Vw with an AC voltage waveform for the SVPWM control are output. In addition, when receiving a command to perform the overmodulation PWM control from the mode control unit 5, the two-phase/three-phase conversion unit 25 outputs the AC voltage command values Vu, Vv, and Vw with an AC voltage waveform corresponding to the overmodulation PWM control. When receiving a command to perform the square wave control from the mode control unit 5, the two-phase/three-phase conversion unit 25 outputs the AC voltage command values Vu, Vv, and Vw with an AC voltage waveform corresponding to the square wave control. In this embodiment, the AC voltage command values Vu, Vv, and Vw when the square wave control is performed may be the command values of the on/off switching phases of the switching elements E1 to E6 in the inverter 6. The command values correspond to the on/off control signals of the switching elements E1 to E6 and indicate the phases of the magnetic pole position θ indicating the on/off switching timings of the switching elements E1 to E6.

The U-phase voltage command value Vu, the V-phase voltage command value Vv, and the W-phase voltage command value Vw generated by the two-phase/three-phase conversion unit 25 are input to the control signal generating unit 26. The control signal generating unit 26 generates the switching control signals S1 to S6 for controlling the switching elements E1 to E6 of the inverter 6 shown in FIG. 1 according to the AC voltage command values Vu, Vv, and Vw. The inverter 6 turns on or off each of the switching elements E1 to E6 in response to the switching control signals S1 to S6. In this way, the PWM control (the normal PWM control or the overmodulation PWM control) or the square wave control of the motor 4 is performed.

The d-axis voltage command value Vd and the q-axis voltage command value Vq calculated by the current control unit 24 are input to the modulation factor calculating unit 29. In addition, the DC voltage Vdc detected by the voltage sensor 41 is input to the modulation factor calculating unit 29. The modulation factor calculating unit 29 calculates the modulation factor M on the basis of these values according to the following Formula (4):

M=√(Vd²+Vq²)/Vdc (4)

In this embodiment, the modulation factor M is the ratio of the effective value of the fundamental wave component of the voltage waveform output from the inverter 6 to the DC voltage Vdc. In this embodiment, the modulation factor M is calculated by dividing the effective value of a three-phase line voltage by the DC voltage Vdc. In this embodiment, the modulation factor M corresponds to a voltage index indicating the magnitudes of the voltage command values Vd and Vq with respect to the DC voltage Vdc. As described above, the maximum value (maximum modulation factor Mmax) of the modulation factor M is “0.78” corresponding to the modulation factor M when the square wave control is performed. In this embodiment, the maximum modulation factor Mmax is the square wave threshold value Mb.

The modulation factor M calculated by the modulation factor calculating unit 29 and a predetermined command modulation factor MT are input to the subtractor 30. In this embodiment, the command modulation factor MT is set to the maximum modulation factor Mmax (=0.78). The subtractor 30 subtracts the command modulation factor MT from the modulation factor M to calculate a modulation factor deviation ΔM, as represented by the following Formula (5):

ΔM=M−MT (5)

In this embodiment, the modulation factor deviation ΔM indicates the degree of excess of the voltage command values Vd and Vq from the value of the maximum AC voltage that can be output by the DC voltage Vdc. Therefore, the modulation factor deviation ΔM substantially serves as a voltage deficiency index indicating the degree of deficiency of the DC voltage Vdc.

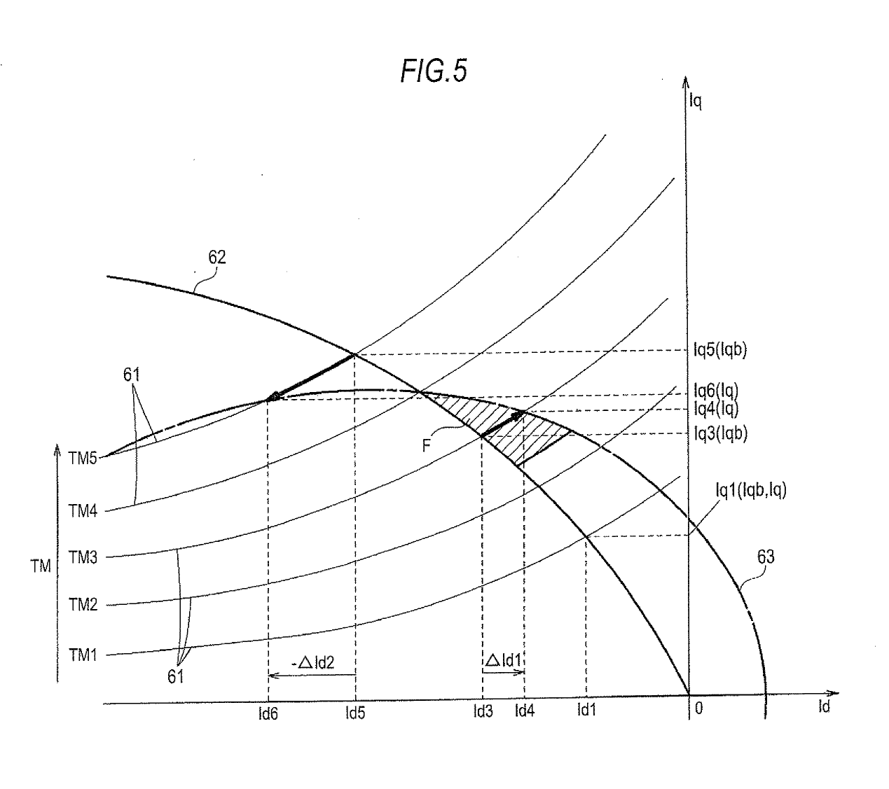

The modulation factor deviation ΔM calculated by the subtractor 30 is input to the integral input adjusting unit 31. The integral input adjusting unit 31 performs predetermined adjustment on the value of the modulation factor deviation ΔM and outputs an adjustment value Y, which is the adjusted value, to the integrator 32. FIG. 6 is a diagram illustrating an example of a conversion map used by an integral input adjusting unit 31. As shown in FIG. 6, in this embodiment, the integral input adjusting unit 31 outputs a positive adjustment value Y (Y>0) when the modulation factor deviation ΔM is equal to or greater than a predetermined strong field start deviation ΔMs (ΔMs<0) and is less than zero (ΔMs≦ΔM<0), outputs a negative adjustment value Y (Y<0) when the modulation factor deviation ΔM is greater than zero (0<ΔM), and outputs zero (Y=0) as the adjustment value Y when the modulation factor deviation ΔM is less than the strong field start deviation ΔMs (ΔM<ΔMs) and when the modulation factor deviation ΔM is zero (ΔM=0). Specifically, the integral input adjusting unit 31 outputs the adjustment value Y that increases as the modulation factor deviation ΔM increases, when the modulation factor deviation ΔM is equal to or greater than the strong field start deviation ΔMs and is less than an intermediate deviation ΔMsm (ΔMs≦ΔM<ΔMsm). In this range, the relationship between the modulation factor deviation ΔM and the adjustment value Y can be represented by a linear function. As such, since a region of the conversion map in which, as the modulation factor deviation ΔM increases, the adjustment value Y increases is set, it is possible to prevent the d-axis current adjustment command value ΔId from rapidly increasing immediately after the strong field control starts. Therefore, it is possible to prevent a rapid change in the current flowing through the coil of the motor 4 or overshooting, and the oscillation of the output torque of the motor 4, which are caused by a rapid change in the adjusted current command values Id and Iq due to a rapid increase in the d-axis current adjustment command value ΔId.

In addition, the integral input adjusting unit 31 outputs the adjustment value Y that decreases as the modulation factor deviation ΔM increases, when the modulation factor deviation ΔM is equal to or greater than the intermediate deviation ΔMsm (ΔMsm≦ΔM). In this range, the adjustment value Y is proportional to the modulation factor deviation ΔM and a proportional constant is a negative value. The strong field start deviation ΔMs is the threshold value of the modulation factor deviation ΔM for starting the strong field control and is set to a value less than zero. The strong field start deviation ΔMs and the command modulation factor MT form the start conditions of the strong field control. Therefore, the strong field start deviation ΔMs is set such that the strong field threshold value Ms determined by the strong field start deviation ΔMs and the command modulation factor MT (=0.78) is an appropriate value. As described above, in this embodiment, the strong field threshold value Ms is set so as to be equal to the overmodulation threshold value Mo (=0.707). Therefore, the strong field start deviation ΔMs is set to “−0.073” (=0.707−0.78). The intermediate deviation ΔMsm is set to a value that is greater than the strong field start deviation ΔMs and is less than zero, for example, “−0.035”. As such, the strong field threshold value Ms is set to a value less than the square wave threshold value Mb (in this embodiment, equal to the command modulation factor MT and the maximum modulation factor Mmax). The strong field control is performed on the condition that the modulation factor M is equal to or greater than the strong field threshold value Ms.

As shown in FIG. 2, the adjustment value Y calculated by the integral input adjusting unit 31 is input to the integrator 32. The integrator 32 integrates the adjustment value Y using a predetermined gain and calculates the integrated value as the d-axis current adjustment command value ΔId. In this embodiment, the d-axis current adjustment command value ΔId is the adjustment values of the base current command values Idb and Iqb and corresponds to a field adjustment command value for adjusting the field flux of the motor 4. The d-axis current adjustment command value ΔId is determined by the modulation factor calculating unit 29, the subtractor 30, the integral input adjusting unit 31, and the integrator 32. Therefore, in this embodiment, the modulation factor calculating unit 29, the subtractor 30, the integral input adjusting unit 31, and the integrator 32 form a field adjusting unit 8. The normal field control (maximum torque control), the strong field control, or the weak field control is selectively performed according to the d-axis current adjustment command value ΔId. When the d-axis current adjustment command value ΔId is zero (ΔId=0), the normal field control (maximum torque control) is performed. When the d-axis current adjustment command value ΔId is a positive value (ΔId>0), the base current command values Idb and Iqb are adjusted to strengthen the field flux of the motor 4. That is, a strong field current, which is a positive d-axis current adjustment command value ΔId, flows to make the field flux of the motor 4 stronger than that in the normal field control and the strong field control is performed. When the d-axis current adjustment command value ΔId is a negative value (ΔId<0), the base current command values Idb and Iqb are adjusted to weaken the field flux of the motor 4. That is, a weak field current, which is a negative d-axis current adjustment command value ΔId, flows to make the field flux of the motor 4 weaker than that in the normal field control, and the weak field control is performed.

As described above, when the modulation factor deviation ΔM is equal to or greater than the strong field start deviation ΔMs and is less than zero (ΔMs≦ΔM<0), a positive value (Y>0) is output as the adjustment value Y. Therefore, the d-axis current adjustment command value ΔId calculated by the integrator 3.2 increases (is changed in the positive direction) and the d-axis current adjustment command value ΔId is changed in a direction in which the field flux of the motor 4 is strengthened. When the modulation factor deviation ΔM is greater than zero (0<ΔM), a negative value (Y<0) is output as the adjustment value Y. Therefore, the d-axis current adjustment command value ΔId calculated by the integrator 32 decreases (is changed in the negative direction) and the d-axis current adjustment command value ΔId is changed in a direction in which the field flux of the motor 4 is weakened. When the modulation factor deviation ΔM is less than the strong field start deviation ΔMs (ΔM<ΔMs) and the modulation factor deviation ΔM is zero (ΔM=0), zero (Y=0) is output as the adjustment value Y. Therefore, the d-axis current adjustment command value ΔId calculated by the integrator 32 is not changed and the d-axis current adjustment command value ΔId is determined such that the field flux of the motor 4 is not changed.

As described above, in the normal field control according to this embodiment, the maximum torque control is performed to adjust the phase of the current such that the output torque of the motor 4 is the maximum with respect to the same current. Therefore, as the d-axis current adjustment command value ΔId is changed from the reference value (ΔId=0) of the d-axis current adjustment command value ΔId for performing the normal field control in a direction in which the field flux of the motor 4 is strengthened, the adjusted current command values Id and Iq required to output the same torque increases, and the voltage command values Vd and Vq calculated on the basis of the adjusted current command values Id and Iq and the modulation factor M increase. In other words, the voltage command determining unit 9 increases the voltage command values Vd and Vq as the d-axis current adjustment command value ΔId increases from the reference value (ΔId=0) (is changed in the positive direction). The modulation factor calculating unit 29 increases the modulation factor M as the d-axis current adjustment command value ΔId increases from the reference value (ΔId=0) (is changed in the positive direction).

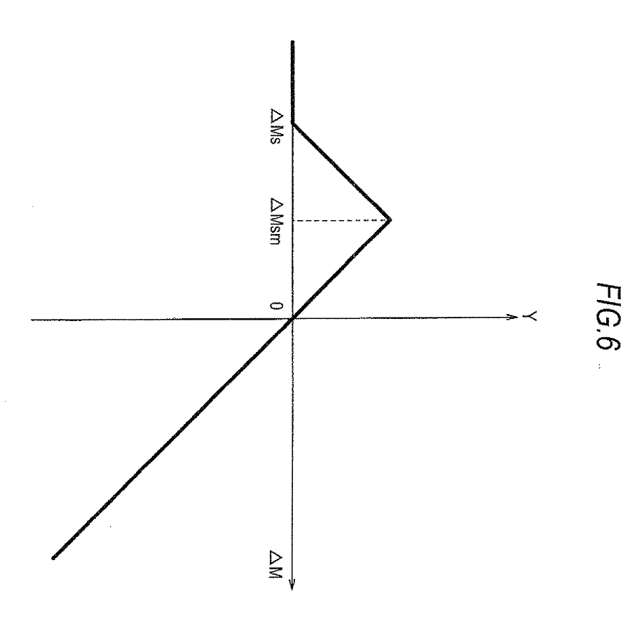

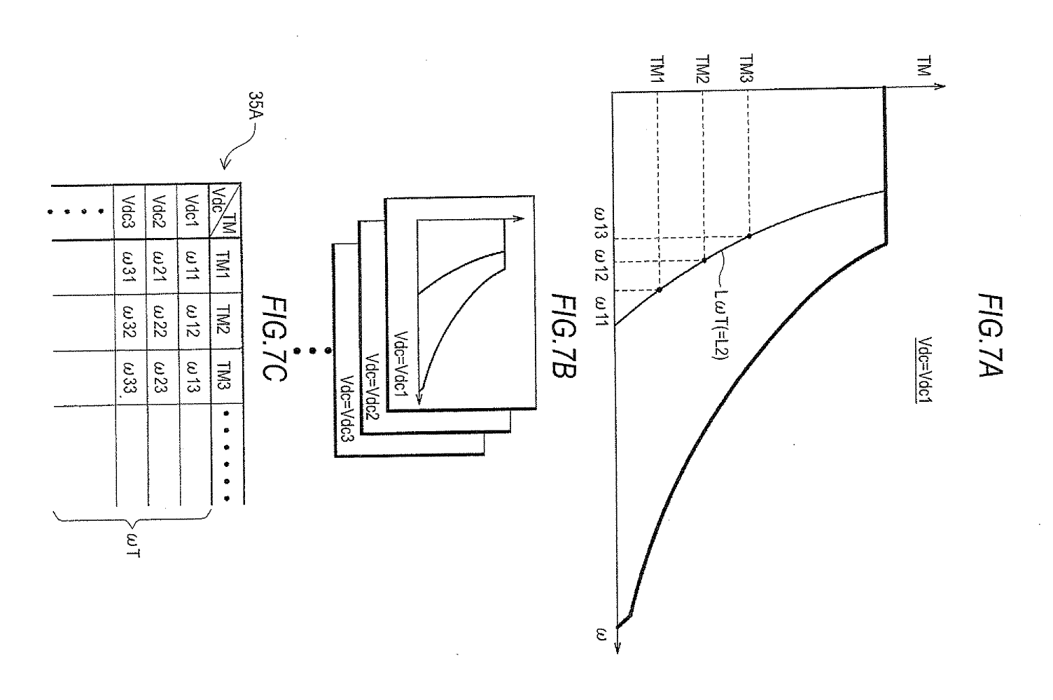

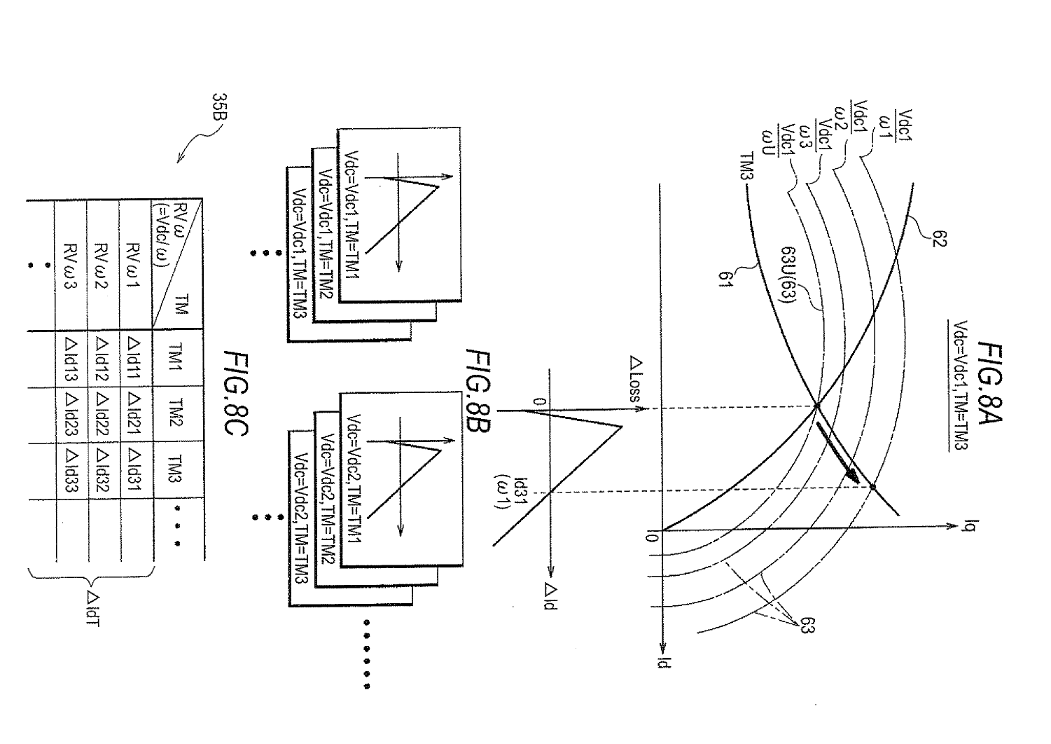

The mode control unit 5 determines the control mode to be performed from a plurality of control modes on the basis of the DC voltage Vdc and the operation state of the motor 4 including the rotational speed ω and the target torque TM, and controls each unit of the control device 2 including the field adjusting unit 8 and the voltage waveform control unit 10 according to the control mode. In addition, the mode control unit 5 determines strong field end conditions during the strong field control, and performs strong field end control for ending the strong field control when the strong field end conditions are satisfied. As shown in FIG. 2, the rotational speed ω, the target torque TM, the DC voltage Vdc, the modulation factor M, and the d-axis current adjustment command value ΔId are input to the mode control unit 5 and the control operation of the mode control unit 5 is performed on the input values. In this embodiment, the mode control unit 5 basically determines the control mode on the basis of the voltage control area map 34 shown in FIG. 3. In addition, the mode control unit 5 determines whether to end the strong field control on the basis of the strong field end condition map shown in FIGS. 7A to 7C and FIGS. 8A to 8C during the strong field control. Details of the mode control unit 5 will be described below.

### 2-3. Details of Mode Control Unit

As shown in FIG. 3, the mode control unit 5 changes the control mode in the order of the normal field/normal PWM control mode A1a, the normal field/overmodulation PWM control mode A1b, the weak field/overmodulation PWM control mode A4a, and the weak field/square wave control mode A5 except for the strong field control area F as the rotational speed ω and the target torque TM of the motor 4 increase. As described above, the boundaries (the curves L1, L2, and L3) between the control modes are set at positions where the modulation factor M is constant during the normal field control (maximum torque control). Among the curves, the curve L1 is set at a position where the modulation factor M is the maximum modulation factor Mmax (=0.78) during the normal field control. When the modulation factor M calculated such that the normal field control can be performed on the basis of the rotational speed ω and the target torque TM is greater than the maximum modulation factor Mmax, the control device 2 performs the weak field/square wave control mode A5.

The strong field control area F is set in the strong field permissible torque range TMR defined for the target torque TM. In addition, the strong field control area F is set to an area (Ms≦M<Mmax) in which the modulation factor M is from the strong field threshold value Ms (curve L2) to the maximum modulation factor Mmax (curve L1) when it is assumed that the strong field control is not performed, but the normal field control is performed on the entire region outside the weak field control area (the region in which the weak field/square wave control mode A5 is performed). The strong field threshold value Ms is determined by the setting of both the command modulation factor MT and the strong field start deviation ΔMs. That is, in the state in which the modulation factor M gradually increases close to the command modulation factor MT, the integral input adjusting unit 31 outputs a positive adjustment value Y (Y>0) when the modulation factor deviation ΔM is equal to or greater than the strong field start deviation ΔMs (ΔMs<0) and is less than zero (ΔMs≦ΔM<0), as described above. As represented by Formula (5), the modulation factor deviation ΔM is calculated by subtracting the command modulation factor MT from the modulation factor M. Therefore, the strong field threshold value Ms, which is the value of the modulation factor M when the strong field control starts, is calculated by adding the strong field start deviation ΔMs to the command modulation factor MT, as represented by the following Formula (6):

Ms=MT+ΔMs (6)

In this embodiment, since the command modulation factor MT is set to “0.78” and the strong field start deviation ΔMs is set to “−0.073”, the strong field threshold value Ms is “0.707” that is equal to the overmodulation threshold value Mo. Therefore, when the modulation factor M is greater than the strong field threshold value Ms during the normal field/normal PWM control mode A1a with the target torque TM within the strong field permissible torque range TMR, that is, when the operating point of the motor 4 is within the strong field control area F, the field adjusting unit 8 starts the strong field control.

The mode control unit 5 controls the voltage waveform control unit 10 to perform the square wave control when the modulation factor M is equal to or greater than the square wave threshold value Mb (maximum modulation factor Mmax), and controls the voltage waveform control unit 10 to perform the PWM control when the modulation factor M is less than the square wave threshold value Mb. In this embodiment, since the PWM control includes the normal PWM control and the overmodulation PWM control, the mode control unit 5 controls the voltage waveform control unit 10 to perform the normal PWM control when the modulation factor M is less than the square wave threshold value Mb and is equal to or less than the overmodulation threshold value Mo (=0.707), and controls the voltage waveform control unit 10 to perform the overmodulation PWM control when the modulation factor M is greater than the overmodulation threshold value Mo (=0.707). As described above, the voltage waveform control unit 10 includes the two-phase/three-phase conversion unit 25 and the control signal generating unit 26, which perform the voltage waveform control including the PWM control and the square wave control.

When the operating point of the motor 4 determined by the rotational speed ω and the target torque TM is within the strong field control area F, a positive adjustment value Y is output from the integral input adjusting unit 31 by the setting of the command modulation factor MT and the strong field start deviation ΔMs, and a positive d-axis current adjustment command value ΔId is output from the integrator 32. In this way, the strong field control starts. As described above, the strong field threshold value Ms (curve L2) defining the strong field control area F is determined by the command modulation factor MT (=0.78) and the strong field start deviation ΔMs (=−0.073). In this example, the strong field threshold value Ms is equal to the overmodulation threshold value Mo (=0.707). After the strong field control starts, first, the mode control unit 5 controls the voltage waveform control unit 10 to perform the PWM control. In this example, since the modulation factor M is the overmodulation threshold value Mo when the strong field control starts, the mode control unit 5 controls the voltage waveform control unit 10 to perform the overmodulation PWM control. That is, when the strong field control starts, first, the mode control unit 5 performs the strong field/overmodulation PWM control mode A2b. Then, the modulation factor M is gradually increased by the strong field control and finally reaches the square wave threshold value Mb. After the modulation factor M reaches the square wave threshold value Mb, the mode control unit 5 controls the voltage waveform control unit 10 to perform the square wave control. In this way, the strong field/square wave control mode A3 is performed.

However, after the modulation factor M is greater than the strong field threshold value Ms and the strong field control starts, the field adjusting unit S adjusts the d-axis current adjustment command value ΔId such that the modulation factor M is equal to the command modulation factor MT. The command modulation factor MT is the maximum modulation factor Mmax (=0.78), which is the square wave threshold value Mb. Therefore, after the strong field control starts, the modulation factor M finally converges on the maximum modulation factor Mmax. As such, after the modulation factor M reaches the maximum modulation factor Mmax, which is the square wave threshold value Mb, the mode control unit 5 performs the voltage waveform control unit 10 to perform the square wave control. When the modulation factor M is changed with a variation in the target torque TM or the rotational speed ω of the motor 4 from this state, the modulation factor deviation ΔM is also changed with the change in the modulation factor M. Therefore, the field adjusting unit 8 appropriately changes the d-axis current adjustment command value ΔId in a direction the field flux is strengthened or weakened. In this way, the d-axis current adjustment command value ΔId is appropriately changed from the positive value where the strong field control is performed to the negative value where the weak field control is performed. When the d-axis current adjustment command value ΔId is a negative value, the weak field control is performed. Even when any one of the strong field control and the weak field control is performed, the modulation factor M converges on the maximum modulation factor Mmax, which is the square wave threshold value Mb, and the square wave control is continuously performed.

### 2-4. Strong Field End Control

As described above, in the control device 2 according to this embodiment, during the square wave control, the d-axis current adjustment command value ΔId is determined such that the modulation factor M is maintained at the maximum modulation factor Mmax, which is the square wave threshold value Mb, and the strong field control or the weak field control is performed. Therefore, in the structure in which the square wave control and the PWM control are switched by only the modulation factor M, even when the operation state of the motor 4 is changed, the square wave control does not end. That is, even when the rotational speed ω or/and the target torque TM are reduced and the operating point of the motor 4 is within the region of the normal field/normal PWM control mode A1a which is on the left side of the curve L2 in FIG. 3, an increase in the d-axis current adjustment command value ΔId in a direction in which the field flux is strengthened alone is insufficient to end the square wave control and the strong field control. Therefore, efficiency is likely to be reduced by an increase in the d-axis current adjustment command value ΔId or, for example, oscillation is likely to occur in the output torque of the motor 4 due to the square wave control performed in the region in which the rotational speed ω is low. Therefore, in this case, the mode control unit 5 performs the strong field end control to appropriately end the strong field control, thereby ending the square wave control.

That is, the mode control unit 5 determines the strong field end conditions, which are conditions for ending the strong field control, on the basis of the target torque TM, the DC voltage Vdc, and the d-axis current adjustment command value ΔId. When the strong field end conditions are satisfied, the mode control unit 5 ends the strong field control performed by the field adjusting unit 8. In this embodiment, it is assumed that the strong field end conditions satisfy any one of the following three conditions (A), (B), and (C):

(A) The rotational speed ω of motor 4<the rotational speed threshold value ωT;

(B) The d-axis current adjustment command value ΔId the adjustment command threshold value ΔIdT; and

(C) The target torque TM is beyond the strong field permissible torque range TMR.

In this embodiment, as shown in the condition (C), since the condition that the target torque TM is beyond the strong field permissible torque range TMR is also included in the strong field end conditions to be determined, the control operation is regulated such that the strong field control is performed only in the strong field permissible torque range TMR. Next, the strong field end conditions and an operation for ending the strong field control will be described in detail.

### 2-4-1. Strong Field End Condition (A): End Condition Based on Rotational Speed ω

As described above, the mode control unit 5 uses the end condition based on the rotational speed ω of the motor 4 as the strong field end condition (A). That is, the mode control unit 5 ends the strong field control performed by the field adjusting unit 8 on the condition that the rotational speed ω of the motor 4 is less than the rotational speed threshold value ωT determined by the target torque TM and the DC voltage Vdc (ω<ωT). In this embodiment, the rotational speed ω of the motor 4 where the modulation factor M is the strong field threshold value Ms (=0.707) during the normal field control is the rotational speed threshold value ωT according to the values of both the target torque TM and the DC voltage Vdc.

The control device 2 includes a rotational speed threshold value map 35A (see FIG. 7C) that defines an appropriate rotational speed threshold value ωT in association with the target torque TM and the DC voltage Vdc as a strong field end condition map 35 (see FIG. 1). The mode control unit 5 calculates an appropriate rotational speed threshold value ωT corresponding to the target torque TM and the DC voltage Vdc on the basis of the rotational speed threshold value map 35A. FIGS. 7A to 7C are conceptual diagrams illustrating a method of calculating the rotational speed threshold value ωT, that is, a method of creating the rotational speed threshold value map 35A.

The appropriate rotational speed threshold value ωT may be experimentally calculated by the actual control device 2. For example, as shown in FIG. 7A, first, an arbitrary voltage is selected from the range of the DC voltage Vdc acquired by the DC power supply 3. In this embodiment, “Vdc1” is selected from the range of the DC voltage Vdc (Vdc=Vdc1). In addition, an arbitrary torque, for example, “TM1” is selected from the range of the target torque TM that can be acquired by the motor 4 (TM=TM1). Then, the selected DC voltage Vdc=Vdc1 and the selected target torque TM=TM1 are input to the control device 2 and the inverter 6 performs the PWM control (here, the normal PWM control) to gradually increase the rotational speed ω of the motor 4 from zero. Then, the d-axis current adjustment command value ΔId corresponding to the rotational speed ω is measured, and the rotational speed ω at the moment when the d-axis current adjustment command value ΔId is changed from zero to a positive value is measured. As described above, the field adjusting unit 8 is configured such that a positive d-axis current adjustment command value ΔId is output when the modulation factor M is greater than the strong field threshold value Ms. Therefore, it is possible to measure the rotational speed ω when the modulation factor M is the strong field threshold value Ms by monitoring the d-axis current adjustment command value ΔId. In the example shown in FIG. 7A, in this case, the rotational speed ω is “ω11”. The rotational speed ω=ω1 calculated in this way is the rotational speed threshold value ωT at the DC voltage Vdc=Vdc1 and the target torque TM=TM1. That is, the rotational speed threshold value ωT=ω1 is a value of the rotational speed threshold value map 35A (see FIG. 7C) corresponding to the DC voltage Vdc=Vdc1 and the target torque TM=TM1 serving as parameters.

Then, various torques are selected from the range of the target torque TM that can be acquired by the motor 4 while maintaining the DC voltage Vdc=Vdc1. Similarly, the rotational speed ω of the motor 4 gradually increases from zero and the rotational speed ω at the moment when the d-axis current adjustment command value ΔId is changed from zero to a positive value is measured while performing the PWM control. In the example shown in FIG. 7A, the rotational speed ω is “ω12” at the target torque TM=TM2 and the rotational speed ωis “ω13” at the target torque TM=TM3. As represented by a curve LωT in FIG. 7A, when the DC voltage Vdc is “Vdc1”, it is possible to calculate the relationship between the target torque TM and the rotational speed ω where the modulation factor M is the strong field threshold value Ms (=0.707) during the normal field control by selecting many torques and measuring the rotational speed ω for each torque. The curve LωT is theoretically identical to the curve L2 where the modulation factor M is the overmodulation threshold value Mo (=0.707). As shown in FIG. 7B, the calculated relationship (curve LωT) between the target torque TM and the rotational speed ω is used as a map of the rotational speed threshold value ωT for the DC voltage Vdc=Vdc1. Then, various voltages, such as a DC voltage Vdc=Vdc2, a DC voltage Vdc=Vdc3, are selected in the range of the DC voltage Vdc that can be acquired by the DC power supply 3. Similarly, the relationship between the target torque TM and the rotational speed ω where the modulation factor M is the strong field threshold value Ms (=0.707) is calculated. Then, the relationship between the target torque TM and the rotational speed ω calculated for each DC voltage Vdc is used as a map of the rotational speed threshold value ωT for each DC voltage Vdc and is registered in the rotational speed threshold value map 35A.

As described above, as shown in FIG. 7C, the rotational speed threshold value map 35A that defines an appropriate rotational speed threshold value ωT in association with the target torque TM and the DC voltage Vdc can be created. The control device 2 includes the rotational speed threshold value map 35A as a portion of the strong field end condition map 35 shown in FIG. 1 such that the mode control unit 5 can refer to the rotational speed threshold value map 35A.

2-4-2. Strong Field End Condition (B): End Condition Based on d-Axis Current Adjustment Command Value ΔId

As described above, the mode control unit 5 uses the end condition based on the d-axis current adjustment command value ΔId serving as the field adjustment command value as the strong field end condition (B). That is, the mode control unit 5 ends the strong field control performed by the field adjusting unit 8 on the condition that the d-axis current adjustment command value ΔId is equal to or greater than the adjustment command threshold value ΔIdT on the basis of the target torque TM and a voltage/speed ratio RVω in the direction in which the field flux is strengthened (ΔId≦ΔIdT). The voltage/speed ratio RVω is the ratio of the DC voltage Vdc to the rotational speed ω of the motor 4. This embodiment is focused on the relationship between the effect of reducing the switching loss of the inverter 6 obtained by performing the strong field control and the square wave control and a reduction in efficiency due to an increase in the d-axis current adjustment command value ΔId in the direction in which the field flux is strengthened. Specifically, the loss of the motor 4 and the motor driving apparatus I when the normal field/PWM control mode A1 (here, the normal field/normal PWM control mode A1a) is performed is referred to as a normal loss Loss1, the loss of the motor 4 and the motor driving apparatus 1 when the strong field/square wave control mode A3 is performed is referred to as a strong field loss Loss2, and an efficiency increment obtained by the execution of the strong field control is referred to as a loss difference ΔLoss (=Loss1−Loss2). The upper limit of the range of the d-axis current adjustment command value ΔId where the strong field loss Loss2 is less than the normal loss Loss1, that is, the loss difference ΔLoss is positive (ΔLoss>0) in the direction in which the field flux is strengthened is referred to as the adjustment command threshold value ΔIdT.

The control device 2 has an adjustment command threshold value map 3513 (see FIG. 8C) that defines an appropriate adjustment command threshold value ΔIdT in association with the target torque TM and the voltage/speed ratio RVω as the strong field end condition map 35 (see FIG. 1). The mode control unit 5 calculates an appropriate adjustment command threshold value ΔIdT corresponding to the target torque TM and the voltage/speed ratio RVω on the basis of the adjustment command threshold value map 35B. FIGS. 8A to 8C are conceptual diagrams illustrating a method of calculating the adjustment command threshold value ΔIdT, that is, a method of creating the adjustment command threshold value map 35B.

The appropriate adjustment command threshold value ΔIdT can be experimentally calculated by the actual control device 2. For example, as shown in FIG. 8A, first, an arbitrary voltage is selected from the range of the DC voltage Vdc that can be acquired by the DC power supply 3 and an arbitrary torque is selected from the range of the target torque TM that can be acquired by the motor 4. In this embodiment, for example, “Vdc1” is selected as the DC voltage Vdc and “TM3” is selected as the target torque TM (Vdc=Vdc1 and TM=TM3). Then, a PWM available upper limit speed ωU, which is the rotational speed ω capable of performing the PWM control, is calculated at the selected DC voltage Vdc=Vdc1 and the selected target torque TM=TM3. The PWM available upper limit speed ωU can be calculated as the rotational speed ω of a voltage limit ellipse 63U passing through an intersection point between the maximum torque control line 62 and the equal torque line 61 of the target torque TM =TM3 in the Id-Ig plane shown in FIG. 8A when the DC voltage Vdc=Vdc1 is established. Then, the selected DC voltage Vdc=Vdc1 and the selected target torque TM=TM3 are input to the control device 2, and the inverter 6 performs the PWM control (here, the normal PWM control) to gradually reduce the rotational speed ω of the motor 4 from the PWM available upper limit speed ωU. Then, the relationship between the d-axis current adjustment command value ΔId that varies depending on the rotational speed ω and the normal loss Loss1 is measured. At the same DC voltage Vdc and target torque TM, the inverter 6 performs the square wave control to gradually reduce the rotational speed ω of the motor 4 from the PWM available upper limit speed ωU. Then, the relationship between the d-axis current adjustment command value ΔId that varies depending on the rotational speed to and the strong field loss Loss2 is measured. Each of the normal loss Loss1 and the strong field loss Loss2 includes the copper loss and iron loss of the motor 4 and the switching loss of the motor driving apparatus 1 in the PWM control or the square wave control, and is calculated by the difference between power supplied from the DC power supply 3 to the motor driving apparatus 1 and the output of the motor 4.

In this way, the relationship between the d-axis current adjustment command value ΔId that varies depending on the rotational speed ω, the normal loss Loss1, and the strong field loss Loss2 is calculated. As shown in FIG. 8A, the relationship between the d-axis current adjustment command value ΔId that varies depending on the rotational speed ω and a loss difference ΔLoss is calculated from the difference (Loss1−Loss2) between the normal loss Loss1 and the strong field loss Loss2 at each d-axis current adjustment command value ΔId (rotational speed ω). Then, the rotational speed ω and the d-axis current adjustment command value ΔId at the moment when the loss difference ΔLoss is changed from a positive value to a negative value (at the moment when the loss difference ΔLoss is 0) is measured on the basis of the relationship between the d-axis current adjustment command value ΔId and the loss difference ΔLoss. In the example shown in FIG. 8A, in this case, the rotational speed ω is “ω1”, and the d-axis current adjustment command value ΔId is “ΔId31”. The ratio between the calculated rotational speed to ω=ω1 and the DC voltage Vdc=Vdc1 is the voltage/speed ratio RVω1. The calculated d-axis current adjustment command value ΔId=ΔId31 is the adjustment command threshold value ΔIdT at the voltage/speed ratio RVω=RVω1 and the target torque TM=TM3. That is, the adjustment command threshold value ΔIdT=ΔId31 is a value of the adjustment command threshold value map 35B (see FIG. 8C) corresponding to the voltage/speed ratio RVω=RVω1 and the target torque TM=TM3 serving as parameters.

Then, as shown in FIG. 8B, various torques, such as a target torque TM=TM1, a target torque TM=TM2, . . . , are selected from the range of the target torque TM that can be acquired by the motor 4 while maintaining the DC voltage Vdc=Vdc1. Similarly, the relationship between the d-axis current adjustment command value ΔId that varies depending on the rotational speed ω and the loss difference ΔLoss is calculated. Then, the rotational speed ω and the d-axis current adjustment command value ΔId at the moment when the loss difference ΔLoss is changed from a positive value to a negative value is calculated for each target torque TM. The ratio of the DC voltage Vdc to the rotational speed ω is the voltage/speed ratio RVω, and the calculated d-axis current adjustment command value ΔId is the adjustment command threshold value ΔIdT at the voltage/speed ratio RVω and the target torque TM. In addition, various voltages, such as a DC voltage Vdc=Vdc2, a DC voltage Vdc=Vdc3, . . . , are selected from the range of the DC voltage Vdc that can be acquired by the DC power supply 3. Similar to the above, various target torques TM are selected for each DC voltage Vdc, and the relationship between the d-axis current adjustment command value ΔId that varies depending on the rotational speed ω and the loss difference ΔLoss is calculated. Then, the rotational speed ω and the d-axis current adjustment command value ΔId at the moment when the loss difference ΔLoss is changed from a positive value to a negative value is calculated for each combination of the DC voltage Vdc and the target torque TM. The ratio of the DC voltage Vdc to the rotational speed ω is the voltage/speed ratio RVω, and the calculated d-axis current adjustment command value ΔId is the adjustment command threshold value ΔIdT at the voltage/speed ratio RVω and the target torque TM. Then, the relationship between the voltage/speed ratio RVω, the target torque TM, and the adjustment command threshold value ΔIdT is registered as a map of the adjustment command threshold value ΔIdT in the adjustment command threshold value map 35B.

In this way, as shown in FIG. 8C, the adjustment command threshold value map 35B that defines an appropriate adjustment command threshold value ΔIdT in association with the target torque TM and the voltage/speed ratio RVω can be created. The control device 2 includes the adjustment command threshold value map 35B as a portion of the strong field end condition map 35 shown in FIG. 1 such that the mode control unit 5 can refer to the adjustment command threshold value map 35B. In the above-mentioned method, the voltage/speed ratio RVω serving as a parameter of the adjustment command threshold value ΔIdT is calculated on the basis of the rotational speed ω at the moment when the loss difference ΔLoss is changed from a positive value to a negative value. Therefore, in some cases, the voltage/speed ratio RVω forming the vertical axis of the adjustment command threshold value map 35B does not have the same value for each target torque TM. In this case, preferably, the adjustment command threshold value ΔIdT when the voltage/speed ratio RVω is equal to a predetermined value is calculated by a linear interpolation method and a map of the adjustment command threshold value ΔIdT is created.

### 2-4-3. Strong Field End Condition (C): End Condition Based on Strong Field Permissible Torque Range TMR

In this embodiment, the mode control unit 5 uses the end condition based on the strong field permissible torque range TMR as the strong field end condition (C). That is, the mode control unit 5 ends the strong field control such that the field adjusting unit 8 does not perform the strong field control when the target torque TM of the motor 4 is beyond a predetermined strong field permissible torque range TMR. That is, when the upper limit of the strong field permissible torque range TMR is a permissible torque upper limit TMRH, the lower limit thereof is a permissible torque lower limit TMRL, and the target torque TM is less than the permissible torque lower limit TMRL or the target torque TM is greater than the permissible torque upper limit TMRH, the mode control unit 5 ends the strong field control. For example, it is preferable that the permissible torque upper limit TMRH be set such that the amount of current flowing through the armature coil of the motor 4 is not greater than the permissible current limit value of the motor 4 when the square wave control in which the amount of harmonic components other than the fundamental wave component of the AC current flowing through the motor 4 is likely to increase. For example, it is preferable that the permissible torque lower limit TMRL be set such that the torque range which is not suitable to perform the square wave control since the output torque is too small is excluded from the strong field permissible torque range TMR.

### 2-4-4. Operation of Ending Strong Field Control

When any one of the strong field end conditions (A) to (C) is satisfied, the mode control unit 5 performs control to change the d-axis current adjustment command value ΔId to zero. That is, when the strong field end conditions are satisfied, the mode control unit 5 outputs a command to change the d-axis current adjustment command value ΔId to zero to the integrator 32, thereby changing the d-axis current adjustment command value ΔId output from the integrator 32 to zero. In this case, the mode control unit 5 controls the field adjusting unit 8 to change the d-axis current adjustment command value ΔId from the current value to zero at a constant rate of change. That is, since the d-axis current adjustment command value ΔId is a positive value during the strong field control, the mode control unit 5 gradually decreases (reduces) the d-axis current adjustment command value ΔId from the current value to zero over time in order to end the strong field control. As such, when ending the strong field control, the mode control unit 5 gradually changes the d-axis current adjustment command value ΔId in a direction in which the amount of adjustment of the field flux is reduced, thereby gradually reducing the modulation factor M. In this way, the control unit 5 gradually reduces the modulation factor M from the square wave threshold value Mb (maximum modulation factor Mmax=0.78) where the square wave control mode is performed, and performs the strong field/overmodulation PWM control mode A2b (strong field/PWM control mode A2) while the d-axis current adjustment command value ΔId is changed to zero and while the modulation factor M becomes the overmodulation threshold value Mo (=0.707). When the d-axis current adjustment command value ΔId is zero and the modulation factor M is less than the overmodulation threshold value Mo, the control mode is changed to the normal field/normal PWM control mode A1a (normal field/PWM control mode A1).

In this embodiment, when ending the strong field control, the mode control unit 5 changes the control mode from the strong field/square wave control mode A3 to the normal field/PWM control mode A1 through the strong field/PWM control mode A2. In this way, it is possible to prevent a rapid change in the adjusted current command values Id and Iq due to the d-axis current adjustment command value ΔId and a rapid change in the modulation factor M when the strong field control ends. Therefore, it is possible to prevent a rapid change in the current flowing through the coil of the motor 4 or overshooting, and the oscillation of the output torque of the motor 4. When all of the strong field end conditions (A), (B), and (C) are not satisfied, the mode control unit 5 stops an end operation for forcibly changing the d-axis current adjustment command value ΔId to zero. In this way, the control operation of controlling the integrator 32 to integrate the adjustment value Y to calculate the d-axis current adjustment command value ΔId is resumed.

### 3. Operation of Control Device

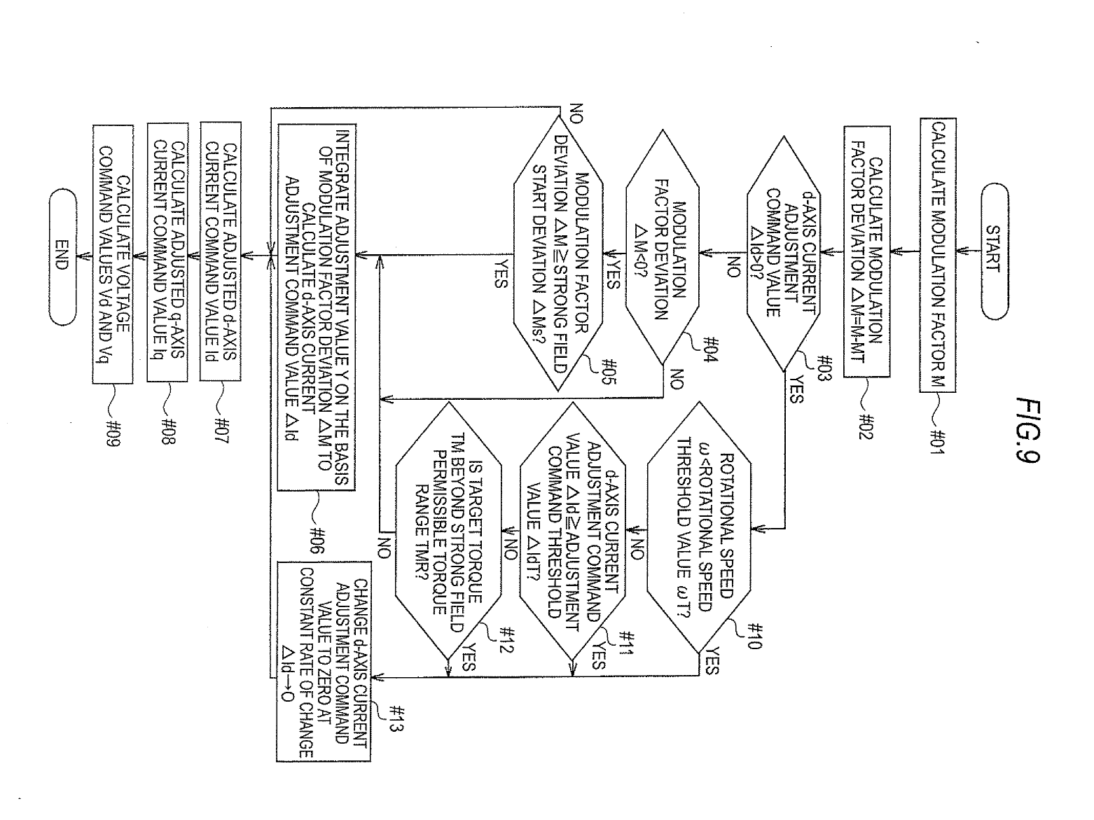

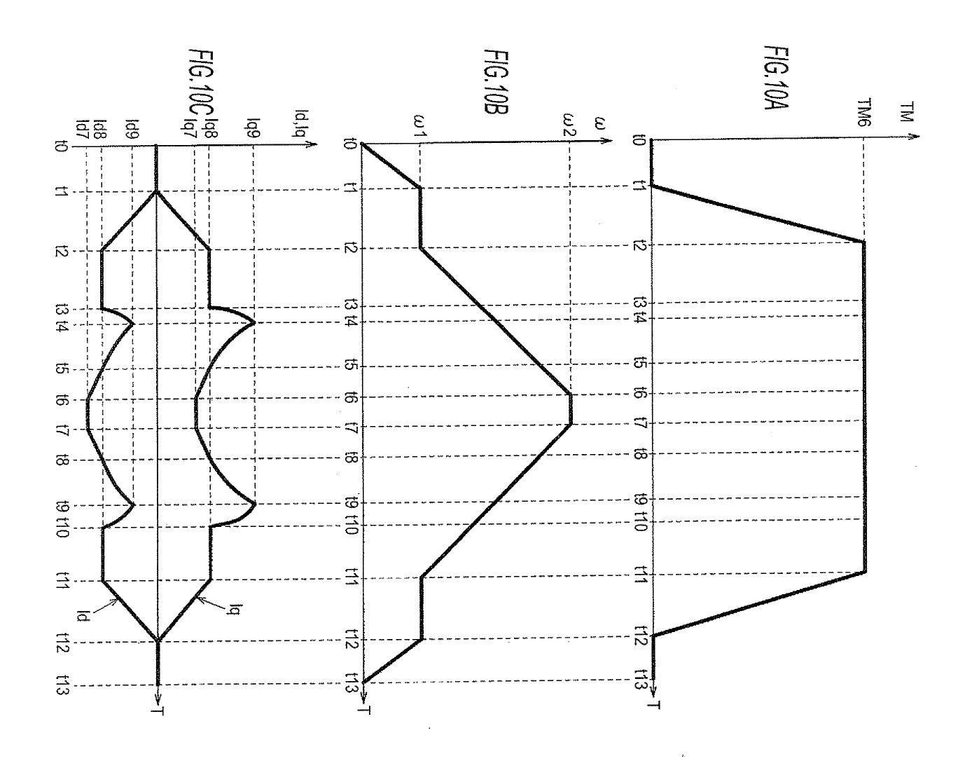

Next, the operation of each unit of the control device 2 will be described in detail with reference to FIG. 9 and FIGS. 10A to 10C. FIG. 9 is a flowchart illustrating the flow of the operation of each unit of the control device 2 according to this embodiment until the voltage command values Vd and Vq are calculated.

As shown in FIG. 9, in the control device 2, first, the modulation factor calculating unit 29 calculates the modulation factor M (Step #01). Then, the subtractor 30 subtracts the command modulation factor MT (maximum modulation factor Mmax=0.78) from the modulation factor M to calculate the modulation factor deviation ΔM (=M−MT) (Step #02). Then, the control device 2 determines whether the d-axis current adjustment command value ΔId is greater than zero (ΔId>0) (Step #03). By this determination, it is determined whether the control device 2 is performing the strong field control. When the d-axis current adjustment command value ΔId is equal to or less than zero (ΔId=0) (Step #03: No), it may be determined that the control device 2 is performing the normal field control or the weak field control. Then, it is determined whether the modulation factor deviation ΔM is less than zero (ΔM<0) (Step #04). By this determination, it is determined whether the modulation factor M is less than the command modulation factor MT. When the modulation factor deviation ΔM is equal to or greater than zero (ΔM>0) (Step #04: No), the process proceeds to Step #06, and the integrator 32 integrates the adjustment value Y (see FIG. 6) equal to or less than zero, which is output from the integral input adjusting unit 31, on the basis of the modulation factor deviation ΔM to calculate the d-axis current adjustment command value ΔId (Step #06). In this way, the d-axis current adjustment command value ΔId is changed in the negative direction, that is, in the direction in which the field flux of the motor 4 is weakened. In this case, the weak field control starts during the normal field control and the intensity of the weak field increases during the weak field control.

When the modulation factor deviation ΔM is less than zero (ΔM<0) (Step #04: Yes), it is determined whether the modulation factor deviation ΔM is equal to or greater than the strong field start deviation ΔMs (ΔM≧ΔMs) (Step #05). When the modulation factor deviation ΔM is less than the strong field start deviation ΔMs (ΔM<ΔMs) (Step #05: No), the integral input adjusting unit 31 outputs zero as the adjustment value Y (see FIG. 6). The process proceeds to Step #07 without integrating the adjustment value Y with the integrator 32. Therefore, the d-axis current adjustment command value ΔId is not changed. In this case, when the control device is performing the normal field control, the normal field control is continuously performed, and when the control device is performing the weak field control, the weak field control is continuously performed. When the modulation factor deviation ΔM is equal to or greater than the strong field start deviation ΔMs (ΔM≧ΔMs) (Step #05: Yes), the integral input adjusting unit 31 outputs a positive value as the adjustment value Y (see FIG. 6). Then, the integrator 32 integrates the positive adjustment value Y to calculate the d-axis current adjustment command value ΔId (Step #06). In this way, the d-axis current adjustment command value ΔId is changed in the positive direction, that is, in the direction in which the field flux of the motor 4 is strengthened. In this case, when the control device is performing the normal field control, the strong field control starts, and when the control device is performing the weak field control, the intensity of the weak field is reduced or the control mode is changed to the strong field control.

When the d-axis current adjustment command value ΔId is greater than zero (ΔId>0) (Step #03: Yes), it may be determined that the control device 2 is performing the strong field control. Then, the mode control unit 5 determines the strong field end conditions (A) to (C). Specifically, the mode control unit 5 determines the condition (A): whether the rotational speed ω of the motor 4 is less than the rotational speed threshold value ωT determined on the basis of the target torque TM and the DC voltage Vdc (ω<ωT) (Step #10), the condition (B): whether the d-axis current adjustment command value ΔId is equal to or greater than the adjustment command threshold value ΔIdT determined on the basis of the target torque TM and the voltage/speed ratio RVω (ΔId≧ΔIdT) (Step #11), and the condition (C): whether the target torque TM of the motor 4 is beyond the predetermined strong field permissible torque range TMR (Step #12). When any of the strong field end conditions (A) to (C) is satisfied (Step #10: Yes, Step #11: Yes, or Step #12: Yes), the mode control unit 5 performs the operation of ending the strong field control. That is, the mode control unit 5 changes the d-axis current adjustment command value ΔId to zero at a constant rate of change in order to end the strong field control (Step #13). In this way, the strong field control ends and the normal field control is performed. When all of the strong field end conditions (A) to (C) are not satisfied (Step #10: No, Step #11: No, and Step #12: No), the strong field control is continuously performed and the process proceeds to Step #06. Therefore, the integrator 32 integrates the adjustment value Y output from the integral input adjusting unit 31 according to the modulation factor deviation ΔM to calculate the d-axis current adjustment command value ΔId (Step #06). In this way, during the strong field control, the d-axis current adjustment command value ΔId is appropriately adjusted according to the modulation factor deviation ΔM. In this case, the d-axis current adjustment command value ΔId may be changed in the negative direction and the control operation may be changed from the strong field control to the weak field control.

Then, the base d-axis current command value Idb calculated by the d-axis current command value calculating unit 21 is added to the d-axis current adjustment command value ΔId calculated by the integrator 32 to calculate the adjusted d-axis current command value Id (Step #07). The q-axis current command value calculating unit 22 calculates the adjusted q-axis current command value Iq (Step #08). Then, the current control unit 24 calculates the voltage command values Vd and Vq on the basis of the adjusted d-axis current command value Id and the adjusted q-axis current command value Iq (Step #18). Then, the process ends.

Next, an example of the operation of the control device 2 based on the flowchart shown in FIG, 9 will be described with reference to FIG. 3 and FIGS. 10A to 10C. FIGS. 10A to 10C are diagrams illustrating an example of a change in the adjusted current command values Id and Iq due to the target torque TM, the rotational speed ω, and the d-axis current adjustment command value ΔId when the operating point of the motor 4 is changed in the order of a point t0 to a point t6 shown in FIG. 3 as time T elapses and then the operating point of the motor 4 is changed in the order of a point t7 to a point t13. Specifically, FIG. 10A shows a change in the target torque TM along the time axis T, FIG. 10B shows a change in the rotational speed ω, and FIG. 10C shows a change in the adjusted d-axis current command value Id and the adjusted q-axis current command value Iq.

In this example, during the period from the time t0 to the time t1, the rotational speed ω increases from zero to ω1 with the target torque TM being zero. In this case, the adjusted d-axis current command value Id and the adjusted q-axis current, command value Iq are maintained at zero. During the period from the time t1 to the time t2, the target torque TM increases from zero to TM6 with the rotational speed ω maintained at ω1. In this case, the adjusted d-axis current command value Id is reduced to Id8 in proportion to the target torque TM, and the adjusted q-axis current command value Iq increases to Iq8 in proportion to the target torque TM. During the period from the time t2 to the time t6, the rotational speed ω increases from ω1 to ω2 with the target torque TM maintained at TM6. In this case, during the period from the time t2 to the time t3 until operating point of the motor 4 is within the strong field control area F, the adjusted d-axis current command value Id and the adjusted q-axis current command value Iq are constantly maintained. During the period from the time t0 to the time t3, the normal field/PWM control mode A1 (normal field/normal PWM control mode A1a) is performed. During the period from the time t3 to the time t4 after the operating point of the motor 4 is within the strong field control area F, the d-axis current adjustment command value ΔId increases and the strong field control is performed. In addition, the adjusted d-axis current command value Id increases from Id8 to Id9 and the adjusted q-axis current command value Iq increases from Iq8 to Iq9. At that time, until the modulation factor M reaches the square wave threshold value Mb (the time t3 to the time t4), the strong field/PWM control mode A2 is performed.

Then, during the period from the time t4 to the time t5, the rotational speed ω increases and the diameter of the voltage limit ellipse 63 shown in FIG. 5 is reduced. During the square wave control, both the adjusted d-axis current command value Id and the adjusted q-axis current command value Iq set on the voltage limit ellipse 63 are reduced. Specifically, the adjusted d-axis current command value Id is reduced from Id9 to Id8 and the adjusted q-axis current command value Iq is reduced from Iq9 to Iq8. In this case, the d-axis current adjustment command value ΔId is also reduced. During the period from the time t4 to the time t5, the strong field/square wave control mode A3 is performed. At the time t5, the d-axis current adjustment command value ΔId is changed to zero and the strong field control ends. During the period from the time t5 to the time t6 after the operating point is out of the strong field control area F, the d-axis current adjustment command value ΔId is further reduced to a negative value and the weak field control is performed. In addition, the adjusted d-axis current command value Id is reduced from Id8 to Id7 and the adjusted q-axis current command value Iq is reduced from Iq8 to Iq7. During the period from the time t6 to the time t7, both the rotational speed ω and the target torque TM are maintained to be constant. Therefore, the adjusted d-axis current command value Id and the adjusted q-axis current command value Iq are not changed.

During the period from the time t7 to the time t11, the rotational speed ω is reduced from ω2 to ω1 with the target torque TM maintained at TM6. In this case, during the period from the time t7 to the time t8 until the operating point of the motor 4 is within the strong field control area F, the weak field control is performed and the d-axis current adjustment command value ΔId increases gradually. In addition, the adjusted d-axis current command value Id increases from Id7 to Id8 and the adjusted q-axis current command value Iq increases from Iq7 to Iq8. At the time 18, the d-axis current adjustment command value ΔId is zero and the weak field control ends. During the period from the time t5 to the time t8, the weak field/square wave control mode A5 is performed. During the period from the time t8 to the time t9 after the operating point of the motor 4 is within the strong field control area F, the rotational speed ω is reduced and the diameter of the voltage limit ellipse 63 shown in FIG. 5 increases. Therefore, during the square wave control, both the adjusted d-axis current command value Id and the adjusted q-axis current command value Iq set on the voltage limit ellipse 63 increase. Specifically, the adjusted d-axis current command value Id increases from Id8 to Id9 and the adjusted q-axis current command value Iq increases from Iq8 to Iq9. In this case, the d-axis current adjustment command value ΔId also increases. During the period from the time t8 to the time 19, the strong field/square wave control mode A3 is performed. In this example, any of the strong field end conditions (A) to (C) is satisfied at the time t9, and the d-axis current adjustment command value ΔId is changed to zero at a constant rate of change (a constant rate of decrease) during the period from the time t9 to the time t10. In this way, the adjusted d-axis current command value Id is reduced from Id9 to Id8 and the adjusted q-axis current command value Iq is reduced from Iq9 to Iq8. Since the rate of decrease of the d-axis current adjustment command value ΔId is regulated in this way, the rate of decrease of the adjusted d-axis current command value Id and the adjusted q-axis current command value Iq obtained by the d-axis current adjustment command value ΔId is also regulated, and the d-axis current adjustment command value ΔId increases so as to draw a gentle curve. In this way, the rate of change (the rate of decrease) of the modulation factor M is regulated and a predetermined period of time is ensured until the modulation factor M reaches the strong field threshold value Ms (curve L2 in FIG. 3). Therefore, during the period (from the time t9 to the time t10), the strong field/PWM control mode A2 is performed.

During the period from the time t10 to the time t11 after the operating point of the motor 4 is out of the strong field control area F, the adjusted d-axis current command value Id and the adjusted q-axis current command value Iq are maintained to be constant. During the period from the time t11 to the time t12, the target torque TM is reduced from TM6 to zero with the rotational speed ω maintained at ω1. In this case, the adjusted d-axis current command value Id increases from Id8 to zero in proportion to the target torque TM, and the adjusted q-axis current command value Iq is reduced from Iq8 to zero in proportion to the target torque TM. During the period from the time t12 to the time t13, the rotational speed ω is reduced from ω1 to zero with the target torque TM being zero. In this case, the adjusted d-axis current command value Id and the adjusted q-axis current command value Iq are maintained at zero. During the period from the time t10 to the time t13, the normal field/PWM control mode A1 (normal field/normal PWM control mode A1a) is performed.

### 4. Other Embodiments

(1) In the above-described embodiment, the case in which the value determined on the basis of the target torque TM and the DC voltage Vdc is used as the rotational speed threshold value ωT used in the strong field end condition (A) is given as an example. However, the embodiment of the invention is not limited thereto. For example, according to one of the exemplary embodiments, the rotational speed threshold value ωT may be set to a constant value regardless of the target torque TM and the DC voltage Vdc. In addition, according to one of the exemplary embodiments, the rotational speed threshold value ωT may be determined on the basis of any one of the target torque TM and the DC voltage Vdc. According to one of the exemplary embodiments, the rotational speed threshold value ωT may be calculated by a predetermined formula on the basis of the target torque TM, the DC voltage Vdc, and the adjustment command threshold value ΔIdT. When the rotational speed threshold value ωT is determined in this way, it is particularly preferable that the strong field control end when both the strong field end condition (A) based on the rotational speed threshold value ωT and the strong field end condition (B) based on the adjustment command threshold value ΔIdT are satisfied. In this case, the mode control unit 5 ends the strong field control on the condition that the d-axis current adjustment command value ΔId is equal to or greater than the adjustment command threshold value ΔIdT in the direction in which the field flux is strengthened and the rotational speed ω is less than the rotational speed threshold value ωT. In this case, it is preferable that the strong field end condition (C) based on the strong field permissible torque range TMR be optional and the strong field control end when any one of the condition (A), the condition (B), and the condition (C) is satisfied.

(2) In the above-described embodiment, the following case is given as an example: the strong field control ends when any one of three strong field end conditions, that is, (A) the rotational speed ω of the motor 4<the rotational speed threshold value ωT, (B) the d-axis current adjustment command value ΔId≧the adjustment command threshold value ΔIdT, and (C) the target torque TM is beyond the strong field permissible torque range TMR is satisfied. However, the embodiment of the invention is not limited thereto. For example, according to one of the exemplary embodiments of the invention, the mode control unit 5 may determine only the strong field end condition (B) and perform the strong field end control only when the condition (B) is satisfied. In addition, according to one of the exemplary embodiments of the invention, the mode control unit 5 may determine the strong field end conditions (A) and (B) or the strong field end conditions (B) and (C) and perform the strong field end control only when any one of the strong field end conditions is satisfied.

(3) In the above-described embodiment, the case in which the rotational speed ω of the motor 4 where the modulation factor M is the strong field threshold value Ms (=0.707) is used as the rotational speed threshold value ωT used in the strong field end condition (A) is given as an example. However, the embodiment of the invention is not limited thereto. The rotational speed threshold value ωT may be set to the rotational speed ω when the modulation factor M is a predetermined value other than the strong field threshold value Ms. Therefore, according to one of the exemplary embodiments of the invention, the rotational speed threshold value ωT may be set to the rotational speed ω when the modulation factor M is a value (for example, M=0.7, M=0.65, or M=0.5) less than the strong field threshold value Ms, or the rotational speed ω when the modulation factor M is a value (for example, M=0.72 or M=0.75) greater than the strong field threshold value Ms. In addition, the rotational speed threshold value ωT is not limited to the rotational speed ω when the modulation factor M is a predetermined value, but a predetermined rotational speed ω determined on the basis of the target torque TM and the DC voltage Vdc may be set as the rotational speed threshold value ωT. For example, according to one of the exemplary embodiments of the invention, the rotational speed ω satisfying TM=−αω+β (α and β are constants) may be set for each value of the DC voltage Vdc and may be used as the rotational speed threshold value ωT.

(4) in the above-described embodiment, the case in which the adjustment command threshold value ΔIdT used in the strong field end condition (B) is set to the upper limit of the range of the d-axis current adjustment command value ΔId where the loss difference ΔLoss (=Loss1−Loss2), which is an efficiency increment obtained by the execution of the strong field control, is positive is given as an example. However, the embodiment of the invention is not limited thereto. For example, the adjustment command threshold value ΔIdT may be set to an arbitrary value in the range of the d-axis current adjustment command value ΔId where the loss difference ΔLoss is positive, or in the range of the d-axis current adjustment command value ΔId where the loss difference ΔLoss is negative. In addition, the adjustment command threshold value ΔIdT may be set as the adjustment command threshold value ΔIdT determined on the basis of the target torque TM and the voltage/speed ratio RVω, regardless of the loss difference ΔLoss.

(5) in the above-described embodiment, the following case is given as an example: during the strong field/square wave control mode, when the strong field control ends, the d-axis current adjustment command value ΔId is gradually reduced at a constant rate of change to gradually decrease the modulation factor M and the control mode is changed to the normal field/pulse width modulation control mode through the strong field/pulse width modulation control mode. However, the embodiment of the invention is not limited thereto. For example, according to one of the exemplary embodiments of the invention, the d-axis current adjustment command value ΔId may be gradually reduced such that the time when the d-axis current adjustment command value ΔId is changed from the current value to zero is constant, regardless of the magnitude of the current value of the d-axis current adjustment command value ΔId when the strong field control ends. In this case, the time until the d-axis current adjustment command value ΔId is changed to the zero is also ensured. Therefore, when the control mode is changed from the strong field/square wave control mode to the normal field/pulse width modulation control mode, it is possible to perform the strong field/pulse width modulation control mode.

(6) In the above-described embodiment, the case in which the strong field threshold value Ms is equal to the overmodulation threshold value Mo (=0.707) is given as an example. However, the embodiment of the invention is not limited thereto. According to one of the exemplary embodiments of the invention, the strong field threshold value Ms may be set to a value (for example, M=0.7, M=0.65, or M=0.5) less than the overmodulation threshold value Mo, or a value (for example, M=0.72 or M=0.75) greater than the overmodulation threshold value Mo. In addition, when the strong field threshold value Ms is set to a value greater than the overmodulation threshold value Mo, the normal field/overmodulation PWM control mode A1b is performed as the normal field/PWM control mode A1 before the strong field control starts.

(7) In the above-described embodiment, the case in which the motor driving apparatus 1 supplies the DC voltage Vdc from the DC power supply 3 to the inverter 6 is given as an example. However, the embodiment of the invention is not limited thereto. For example, according to one of the exemplary embodiments of the invention, a voltage conversion unit, such as a DC-DC converter which converts a power supply voltage from the DC power supply 3 to generate a desired system voltage, may be provided, and the system voltage generated by the voltage conversion unit may be supplied to the inverter 6 which is a DC/AC conversion unit. In this case, the voltage conversion unit may be a step-up converter that steps up the power supply voltage, a step-down converter that steps down the power supply voltage, or a step-up/down converter that steps up and down the power supply voltage.

(8) In the above-described embodiment, the case in which the AC motor 4 is an interior permanent magnet synchronous motor (IPMSM) operated by a three-phase AC. However, the embodiment of the invention is not limited thereto. For example, a surface permanent magnet synchronous motor (SPMSM) may be used as the AC motor 4. Alternatively, for example, induction motors other than the synchronous motor may be used as the AC motor. In addition, a single-phase AC, a two-phase AC, or a polyphase AC with four or more phases, other than a three-phase, may be used as the AC supplied to the AC motor.

(9) In the above-described embodiment, the case in which the motor 4 is used as a driving force source of, for example, an electric vehicle or a hybrid vehicle is given as an example. However, the use of the motor 4 according to this embodiment is not limited thereto, but the invention can be applied to motors for all uses.

The invention can be appropriately used for a control device controlling a motor driving apparatus including a DC/AC conversion unit that converts a DC voltage into an AC voltage and supplies the AC voltage to an AC motor.

What is claimed is:

1. A control device that controls a motor driving apparatus including a DC/AC conversion unit which converts a DC voltage into an AC voltage and supplies the AC voltage to an AC motor, comprising:
a current command determining unit that determines a base current command value, which is a command value of a current supplied from the DC/AC conversion unit to the AC motor, on the basis of a target torque of the AC motor;
a field adjusting unit that determines a field adjustment command value, which is an adjustment value of the base current command value;
a voltage command determining unit that determines a voltage command value, which is a command value of a voltage supplied from the DC/AC conversion unit to the AC motor, on the basis of an adjusted current command value obtained by adjusting the base current command value with the field adjustment command value, and the rotational speed of the AC motor; and
a voltage waveform control unit that controls the DC/AC conversion unit on the basis of the voltage command value to perform voltage waveform control including at least pulse width modulation control and square wave control; and
a mode control unit that controls the field adjusting unit and the voltage waveform control unit,
wherein the voltage waveform control unit performs the pulse width modulation control when a voltage index indicating the magnitude of the voltage command value with respect to the DC voltage is less than a predetermined square wave threshold value, and performs the square wave control when the voltage index is equal to or greater than the square wave threshold value,
the field adjusting unit is configured to perform field control including at least strong field control which determines the field adjustment command value such that the base current command value is adjusted to strengthen a field flux of the AC motor and normal field control which determines the field adjustment command value such that the base current command value is not adjusted, and performs the strong field control on the condition that the voltage index is equal to or greater than a predetermined strong field threshold value less than the square wave threshold value, and
the mode control unit ends the strong field control performed by the field adjusting unit on the condition that the field adjustment command value is equal to or greater than an adjustment command threshold value, which is determined on the basis of the target torque and a voltage/speed ratio indicating the ratio of the DC voltage to the rotational speed of the AC motor, in a direction in which the field flux is strengthened.

2. The control device of the motor driving apparatus according to claim 1,
wherein, in a strong field/square wave control mode in which the strong field control and the square wave control are performed, when ending the strong field control, the mode control unit gradually changes the field adjustment command value in a direction in which the amount of adjustment of the field flux is reduced to gradually reduce the voltage index, thereby changing the control mode to a normal field/pulse width modulation control mode in which the normal field control and the pulse width modulation control are performed through a strong field/pulse width modulation control mode in which the strong field control and the pulse width modulation control are performed.

3. The control device of the motor driving apparatus according to claim 1,
wherein, when the loss of the AC motor and the motor driving apparatus in a normal field/pulse width modulation control mode that performs the normal field control and the pulse width modulation control is a normal loss and the loss of the AC motor and the motor driving apparatus in a strong field/square wave control mode that performs the strong field control and the square wave control is a strong field loss, an upper limit of the range of the field adjustment command value in which the strong field loss is less than the normal loss in the direction in which the field flux is strengthened is the adjustment command threshold value.

4. The control device of the motor driving apparatus according to claim 3,
wherein the mode control unit determines both a condition that the field adjustment command value is equal to or greater than the adjustment command threshold value and a condition that the rotational speed is less than a predetermined rotational speed threshold value, and ends the strong field control when at least one of the conditions is satisfied.

5. The control device of the motor driving apparatus according to claim 4,
wherein the rotational speed threshold value is determined on the basis of the target torque and the DC voltage.

6. The control device of the motor driving apparatus according to claim 5,
wherein the rotational speed where the voltage index is the strong field threshold value during the normal field control is set as the rotational speed threshold value on the basis of both the target torque and the DC voltage.

7. The control device of the motor driving apparatus according to claim 1,
wherein the mode control unit determines both a condition that the field adjustment command value is equal to or greater than the adjustment command threshold value and a condition that the rotational speed is less than a predetermined rotational speed threshold value, and ends the strong field control when at least one of the conditions is satisfied.

8. The control device of the motor driving apparatus according to claim 7,
wherein the rotational speed threshold value is determined on the basis of the target torque and the DC voltage.

9. The control device of the motor driving apparatus according to claim 8,
wherein the rotational speed where the voltage index is the strong field threshold value during the normal field control is set as the rotational speed threshold value on the basis of both the target torque and the DC voltage.

10. The control device of the motor driving apparatus according to claim 1,
wherein the mode control unit controls the field adjusting unit not to perform the strong field control when the target torque of the AC motor is beyond a predetermined strong field permissible torque range.

11. The control device of the motor driving apparatus according to claim 10,
wherein, when ending the strong field control, the mode control unit controls the field adjusting unit to change the field adjustment command value from the current value to zero at a constant rate of change.

12. The control device of the motor driving apparatus according to claim 1,
wherein the voltage command determining unit performs feedback control on the adjusted current command value on the basis of an actual current value, which is the actual value of the current supplied from the DC/AC conversion unit to the AC motor, thereby determining the voltage command value.
